(19) United States
(12) Patent Application Publication
(10) Pub. No.: US 2026/0336665 A1
(43) Pub. Date: Oct. 29, 2026

(54) SIGNAL PROCESSING DEVICE AND VEHICLE DISPLAY APPARATUS INCLUDING THE SAME

(71) Applicant: LG ELECTRONICS INC., Seoul (KR)

(72) Inventors: Sangheon KIM, Seoul (KR); Jooyoung LEE, Seoul (KR)

(73) Assignee: LG ELECTRONICS INC., Seoul (KR)

(21) Appl. No.: 19/122,207

(22) PCT Filed: Oct. 17, 2023
(86) PCT No.: PCT/KR2023/015989

§ 371 Date: Apr. 17, 2025

(30) Foreign Application Priority Data
Oct. 18, 2022 (KR) 10-2022-0134127

(51) Int. Cl. B60W 60/00; B60R 16/023

(52) U.S. Cl. CPC B60W 60/0017; B60R 16/0232; B60W 60/0018; B60R 2300/101; B60R 2300/8033; B60R 2300/8093; B60W 2420/403; B60W 2720/103

(57) ABSTRACT

A signal processing device and a vehicle display apparatus including the same according to an embodiment of the present disclosure include a processor configured to, in a normal mode, transmit sensor data received from a sensor device or camera data received from a camera to a central signal processing device, wherein the processor is configured to perform an emergency mode in response of a failure of the central signal processing device or the sensor device or the camera. Accordingly, it is possible to stably perform vehicle driving.

89

### BACKGROUND

### 1. Technical Field

The present disclosure relates to a signal processing device and a vehicle display apparatus including the same, and more particularly to a signal processing device capable of stably performing vehicle driving, and a vehicle display apparatus including the signal processing device.

### 2. Description of the Related Art

A vehicle is a machine that allows a user to move in a desired direction. A typical example of the vehicle is an automobile.

Meanwhile, a signal processing device for vehicles is mounted in the vehicle for convenience of users who use the vehicle.

Meanwhile, the signal processing device for vehicles can run various applications for vehicle driving.

For example, the signal processing device for vehicles is able to run Advanced Driver Assistance (ADAS) applications or Automatic Driving (AD) applications, etc.

Meanwhile, a signal processing device in a vehicle performs signal processing based on sensor data or camera data, for vehicle driving.

In this regard, there is ongoing research into ways of stably controlling vehicles in the event of an error in sensor data or camera data.

### SUMMARY

It is an objective of the present disclosure to provide a signal processing device capable of stably performing vehicle driving, and a vehicle display apparatus including the same.

It is another objective of the present disclosure to provide a signal processing device capable of stably performing control switching between a plurality of signal processing devices, and a vehicle display apparatus including the same.

An embodiment of the present disclosure provides a signal processing device and a vehicle display apparatus including the same, which exchange data with a central signal processing device, the signal processing device including a processor configured to, in a normal mode, transmit sensor data received from a sensor device or camera data received from a camera to the central signal processing device, wherein the processor is configured to perform an emergency mode in response of a failure of the central signal processing device or the sensor device or the camera.

Meanwhile, in the normal mode, the processor can be configured to operate the sensor device or the camera or an actuator, based on a control signal received based on transmission of the sensor data or the camera data.

Meanwhile in response to the amount of the sensor data or camera data being at or below a first reference value during the normal mode, the processor can be configured to determine that the performance of the sensor device or the camera is degraded and transmit performance degradation information or degradation mode initiation information to the central signal processing device.

Meanwhile, in response to the amount of the sensor data or camera data received being at or below a second reference value which is lower than the first reference value, the processor can be configured to determine that the sensor device or the camera has a failure and perform the emergency mode.

Meanwhile, in the emergency mode, the processor can be configured to transmit failure information or emergency mode initiation information to the central signal processing device.

Meanwhile in response to the amount of the sensor data or camera data received being at or below the first reference value during the normal mode, the processor can be configured to transmit second sensor data or second camera data received from another sensor device or camera different from the sensor device or camera to the central signal processing device.

Meanwhile, the processor can be configured to execute a hypervisor and execute a zonal fault manager on the hypervisor.

Meanwhile, the processor can be further configured to execute a sensor service on the hypervisor for transmitting the sensor data or the camera data, wherein the safety level of the zonal fault manager can be higher than the safety level of the sensor service.

Meanwhile, the processor can be further configured to execute a system fault manager on the hypervisor, wherein the safety level of the zonal fault manager and the safety level of the system fault manager can be the same.

Meanwhile, the processor can be configured to execute a system fault manager.

Meanwhile, the system fault manager can be configured to generate a diagnosis result log based on diagnosis result data received from the central signal processing device.

Meanwhile, the processor can be configured to operate the sensor device or the camera or an actuator, based on a control signal received based on transmission of the sensor data or the camera data, wherein the safety level of the actuator can be higher than the safety level of the sensor device or the camera.

Meanwhile, the processor can be configured to generate an emergency control message based on the emergency mode and emergently control the actuator based on the emergency control message.

Meanwhile, in response to determining that the central signal processing device has a failure, the processor can be configured to switch to the emergency mode, generate a control message for replacing the central signal processing device, and operate the sensor device or the camera or the actuator, based on the control message.

Meanwhile, the processor can be configured to determine an error grade or a recovery grade based on driving status information and fault type information and perform the emergency mode or the degradation mode, based on the error grade or the recovery grade.

Meanwhile, during the emergency mode or the degradation mode, the processor can be configured to recover the previous mode in response to satisfaction of a recovery condition.

Another embodiment of the present disclosure provides a signal processing device and a vehicle display apparatus including the same, which exchange data with a zonal signal processing device, the signal processing device including a processor configured to execute an application for driving the vehicle, based on sensor data or camera data received from the zonal signal processing device, wherein, in response to receiving performance degradation information or degradation mode initiation information from the zonal signal processing device, the processor is configured to perform the degradation mode.

Meanwhile, the processor can be configured to transmit diagnosis result data of the sensor data or camera data to the zonal signal processing device, based on sensor data or camera data received from the zonal signal processing device.

Meanwhile, the processor can be configured to execute a hypervisor and execute a plurality of virtual machines on the hypervisor, wherein one of the plurality of virtual machines can be configured to execute a fault manager.

Meanwhile, the processor can be configured to execute a second fault manager, wherein the safety level of the second fault manager can be higher than the safety level of the fault manager executed on the hypervisor.

An embodiment of the present disclosure provides a vehicle display apparatus including: at least one display; a zonal signal processing device configured to receive sensor data or camera data from a sensor device or a camera; and a central signal processing device configured to output an image signal to the display, based on the sensor data or the camera data.

### Effects of the Disclosure

An embodiment of the present disclosure provides a signal processing device and a vehicle display apparatus including the same, which exchange data with a central signal processing device, the signal processing device including a processor configured to, in a normal mode, transmit sensor data received from a sensor device or camera data received from a camera to the central signal processing device, wherein the processor is configured to perform an emergency mode in response of a failure of the central signal processing device or the sensor device or the camera. Accordingly, it is possible to stably perform vehicle driving.

Meanwhile, in the normal mode, the processor can be configured to operate the sensor device or the camera or an actuator, based on a control signal received based on transmission of the sensor data or the camera data. Accordingly, it is possible to stably perform vehicle driving in the normal mode.

Meanwhile in response to the amount of the sensor data or camera data being at or below a first reference value during the normal mode, the processor can be configured to determine that the performance of the sensor device or the camera is degraded and transmit performance degradation information or degradation mode initiation information to the central signal processing device. Accordingly, it is possible to stably perform vehicle driving in the degradation mode.

Meanwhile, in response to the amount of the sensor data or camera data received being at or below a second reference value which is lower than the first reference value, the processor can be configured to determine that the sensor device or the camera has a failure and perform the emergency mode. Accordingly, it is possible to stably perform vehicle driving in the emergency mode.

Meanwhile, in the emergency mode, the processor can be configured to transmit failure information or emergency mode initiation information to the central signal processing device. Accordingly, it is possible to stably perform vehicle driving.

Meanwhile in response to the amount of the sensor data or camera data received being at or below the first reference value during the normal mode, the processor can be configured to transmit second sensor data or second camera data received from another sensor device or camera different from the sensor device or camera to the central signal processing device. Accordingly, it is possible to stably perform vehicle driving.

Meanwhile, the processor can be configured to execute a hypervisor and execute a zonal fault manager on the hypervisor. Accordingly, it is possible to stably perform vehicle driving.

Meanwhile, the processor can be further configured to execute a sensor service on the hypervisor for transmitting the sensor data or the camera data, wherein the safety level of the zonal fault manager can be higher than the safety level of the sensor service. Accordingly, it is possible to stably perform vehicle driving.

Meanwhile, the processor can be further configured to execute a system fault manager on the hypervisor, wherein the safety level of the zonal fault manager and the safety level of the system fault manager can be the same. Accordingly, it is possible to stably perform vehicle driving.

Meanwhile, the processor can be configured to execute a system fault manager. Accordingly, it is possible to stably perform vehicle driving.

Meanwhile, the system fault manager can be configured to generate a diagnosis result log based on diagnosis result data received from the central signal processing device. Accordingly, it is possible to stably perform vehicle driving.

Meanwhile, the processor can be configured to operate the sensor device or the camera or an actuator, based on a control signal received based on transmission of the sensor data or the camera data, wherein the safety level of the actuator can be higher than the safety level of the sensor device or the camera. Accordingly, it is possible to stably perform vehicle driving. In particular, the actuator whose safety level is higher can be stably controlled.

Meanwhile, the processor can be configured to generate an emergency control message based on the emergency mode and emergently control the actuator based on the emergency control message. Accordingly, it is possible to stably perform vehicle driving in the emergency mode.

Meanwhile, in response to determining that the central signal processing device has a failure, the processor can be configured to switch to the emergency mode, generate a control message for replacing the central signal processing device, and operate the sensor device or the camera or the actuator, based on the control message. Accordingly, it is possible to stably perform vehicle driving in the emergency mode.

Meanwhile, the processor can be configured to determine an error grade or a recovery grade based on driving status information and fault type information and perform the emergency mode or the degradation mode, based on the error grade or the recovery grade. Accordingly, it is possible to stably perform vehicle driving in the emergency mode or the degradation mode.

Meanwhile, during the emergency mode or the degradation mode, the processor can be configured to recover the previous mode in response to satisfaction of a recovery condition. Accordingly, it is possible to stably perform vehicle driving.

Another embodiment of the present disclosure provides a signal processing device and a vehicle display apparatus including the same, which exchange data with a zonal signal processing device, the signal processing device including a processor configured to execute an application for driving the vehicle, based on sensor data or camera data received from the zonal signal processing device, wherein, in response to receiving performance degradation information or degradation mode initiation information from the zonal signal processing device, the processor is configured to perform the degradation mode. Accordingly, possible to stably perform vehicle driving. In particular, it is possible to stably perform vehicle driving in the degradation mode.

Meanwhile, the processor can be configured to transmit diagnosis result data of the sensor data or camera data to the zonal signal processing device, based on sensor data or camera data received from the zonal signal processing device. Accordingly, it is possible to stably perform vehicle driving.

Meanwhile, the processor can be configured to execute a hypervisor and execute a plurality of virtual machines on the hypervisor, wherein one of the plurality of virtual machines can be configured to execute a fault manager. Accordingly, it is possible to stably perform vehicle driving.

Meanwhile, the processor can be configured to execute a second fault manager, wherein the safety level of the second fault manager can be higher than the safety level of the fault manager executed on the hypervisor. Accordingly, it is possible to stably perform vehicle driving.

An embodiment of the present disclosure provides a vehicle display apparatus including: at least one display; a zonal signal processing device configured to receive sensor data or camera data from a sensor device or a camera; and a central signal processing device configured to output an image signal to the display, based on the sensor data or the camera data. Accordingly, it is possible to stably perform vehicle driving.

### BRIEF DESCRIPTION OF THE DRAWINGS

FIG. 1 is a diagram illustrating an example of the exterior and interior of a vehicle;

FIG. 2 is a diagram illustrating an example of a vehicle communication gateway;

FIG. 3A is a diagram illustrating an example of a vehicle display apparatus in a vehicle;

FIG. 3B is a diagram illustrating another example of a vehicle display apparatus in a vehicle;

FIG. 4 is an internal block diagram illustrating an example of the vehicle display apparatus of FIG. 3B;

FIGS. 5A to 5D are diagrams illustrating various examples of a vehicle display apparatus;

FIG. 6 is a block diagram illustrating an example of a vehicle display apparatus according to an embodiment of the present disclosure;

FIG. 7 is an exemplary internal block diagram of a signal processing device according to an embodiment of the present disclosure;

FIG. 8 is a flowchart illustrating a method of operating a vehicle display apparatus according to an embodiment of the present disclosure;

FIG. 9 is a block diagram illustrating another example of a vehicle display apparatus according to an embodiment of the present disclosure;

FIG. 10 is a block diagram illustrating yet another example of a vehicle display apparatus according to an embodiment of the present disclosure;

FIG. 11 is a block diagram illustrating a further example of a vehicle display apparatus according to an embodiment of the present disclosure; and

FIGS. 12A to 19C are diagrams referred to in the description of the operation of FIGS. 8 to 11.

### DETAILED DESCRIPTION

Hereinafter, the present disclosure will be described in detail with reference to the accompanying drawings.

With respect to constituent elements used in the following description, suffixes “module” and “unit” are given only in consideration of ease in preparation of the specification, and do not have or serve different meanings. Accordingly, the suffixes “module” and “unit” can be used interchangeably.

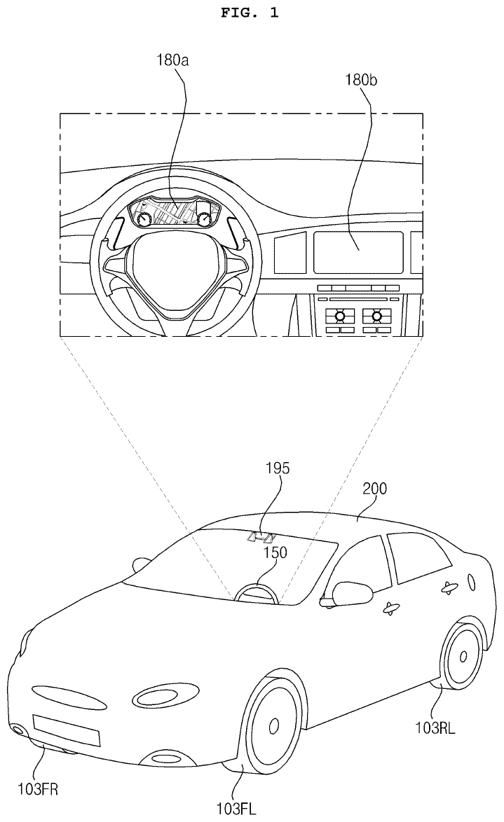

FIG. 1 is a diagram illustrating an example of the exterior and interior of a vehicle.

Referring to the figure, the vehicle 200 is moved by a plurality of wheels 103FR, 103FL, 103RL, . . . rotated by a power source and a steering wheel 150 configured to adjust an advancing direction of the vehicle 200.

Meanwhile, the vehicle 200 can be provided with a camera 195 configured to acquire an image of the front of the vehicle.

Meanwhile, the vehicle 200 can be further provided therein with a plurality of displays 180a and 180b configured to display images and information.

In FIG. 1, a cluster display 180a and an audio video navigation (AVN) display 180b are illustrated as the plurality of displays 180a and 180b. In addition, a head up display (HUD) can also be used.

Meanwhile, the audio video navigation (AVN) display 180b can also be called a center information display.

Meanwhile, the vehicle 200 described in this specification can be a concept including all of a vehicle having an engine as a power source, a hybrid vehicle having an engine and an electric motor as a power source, and an electric vehicle having an electric motor as a power source.

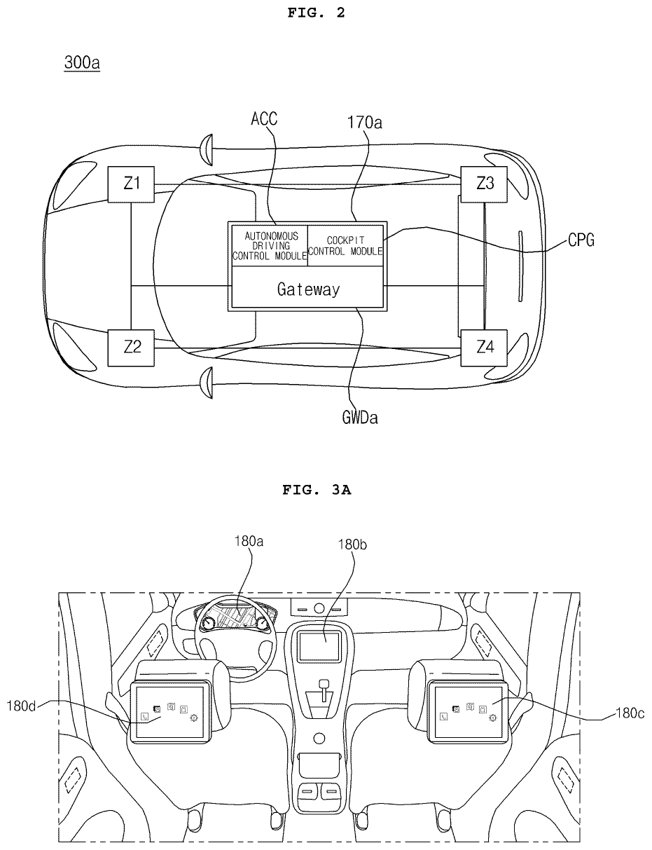

FIG. 2 is a diagram illustrating an example of a vehicle communication gateway.

Referring to the drawing, an architecture 300a of a vehicle communication gateway can correspond to a zone-based architecture.

Accordingly, vehicle internal sensor devices and processors can be mounted in each of a plurality of zones Z1 to Z4, and a signal processing device 170a including a vehicle communication gateway GWDa can be disposed at the center of the plurality of zones Z1 to Z4.

Meanwhile, the signal processing device 170a can further include an autonomous driving control module ACC, a cockpit control module CPG, etc., in addition to the vehicle communication gateway GWDa.

The vehicle communication gateway GWDa in the signal processing device 170a can be a High Performance Computing (HPC) gateway.

That is, as an integrated HPC gateway, the signal processing device 170a of FIG. 2 can exchange data with an external communication module (not shown) or processors (not shown) in the plurality of zones Z1 to Z4.

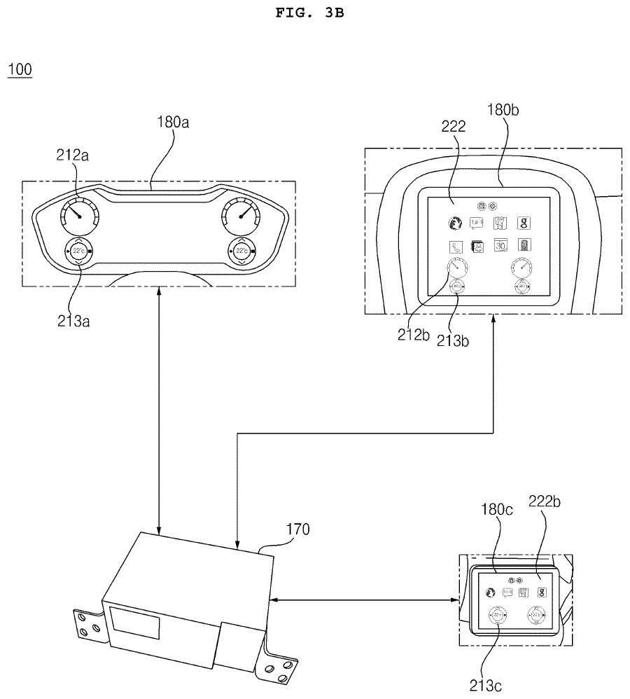

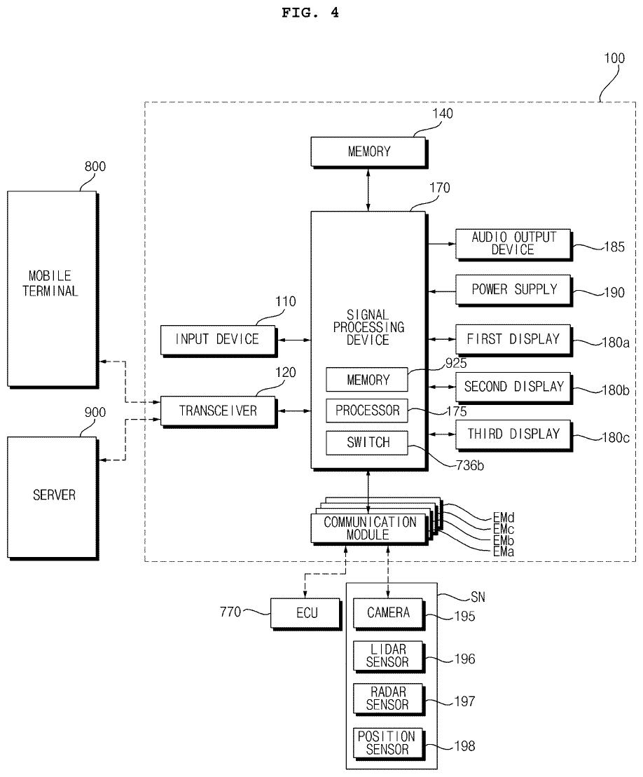

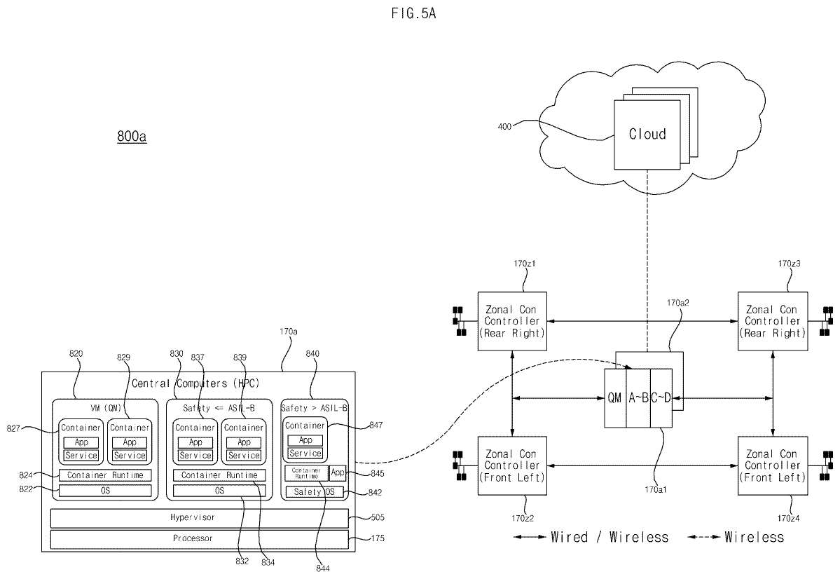

FIG. 3A is a diagram illustrating an example of a vehicle display apparatus in a vehicle.

Referring to the figure, a cluster display 180a, an audio video navigation (AVN) display 180b, rear seat entertainment displays 180c and 180d, and a rear-view mirror display (not shown) can be mounted in the vehicle.

FIG. 3B is a diagram illustrating another example of a vehicle display apparatus in a vehicle.

A vehicle display apparatus 100 according to the embodiment of the present disclosure can include a plurality of displays 180a and 180b and a signal processing device 170 configured to perform signal processing in order to display images and information on the plurality of displays 180a and 180b, and to output an image signal to at least one of the displays 180a and 180b.

The first display 180a, which is one of the plurality of displays 180a and 180b, can be a cluster display 180a configured to display a driving state and operation information, and the second display 180b can be an audio video navigation (AVN) display 180b configured to display vehicle driving information, a navigation map, various kinds of entertainment information, or an image.

The signal processing device 170 can have a processor 175 provided therein, and first to third virtual machines (not shown) can be executed by a hypervisor 505 in the processor 175.

The second virtual machine (not shown) can be operated for the first display 180a, and the third virtual machine (not shown) can be operated for the second display 180b.

Meanwhile, the first virtual machine (not shown) in the processor 175 can be configured to set a shared memory 508 based on the hypervisor 505 for transmission of the same data to the second virtual machine (not shown) and the third virtual machine (not shown). Consequently, the first display 180a and the second display 180b in the vehicle can display the same information or the same images in a synchronized state.

Meanwhile, the first virtual machine (not shown) in the processor 175 shares at least some of data with the second virtual machine (not shown) and the third virtual machine (not shown) for divided processing of data. Consequently, the plurality of virtual machines for the plurality of displays in the vehicle can divide and process data.

Meanwhile, the first virtual machine (not shown) in the processor 175 can receive and process wheel speed sensor data of the vehicle, and can transmit the processed wheel speed sensor data to at least one of the second virtual machine (not shown) or the third virtual machine (not shown). Consequently, at least one virtual machine can share the wheel speed sensor data of the vehicle.

Meanwhile, the vehicle display apparatus 100 according to the embodiment of the present disclosure can further include a rear seat entertainment (RSE) display 180c configured to display driving state information, simple navigation information, various kinds of entertainment information, or an image.

The signal processing device 170 can further execute a fourth virtual machine (not shown), in addition to the first to third virtual machines (not shown), on the hypervisor 505 in the processor 175 to control the RSE display 180c.

Consequently, it is possible to control various displays 180a to 180c using a single signal processing device 170.

Meanwhile, some of the plurality of displays 180a to 180c can be operated based on a Linux Operating System (OS), and others can be operated based on a Web Operating System (OS).

The signal processing device 170 according to the embodiment of the present disclosure can be configured to display the same information or the same images in a synchronized state on the displays 180a to 180c to be operated under various operating systems.

Meanwhile, FIG. 3B illustrates an example in which a vehicle speed indicator 212a and a vehicle internal temperature indicator 213a are displayed on a first display 180a, a home screen 222 including a plurality of applications, a vehicle speed indicator 212b, and a vehicle internal temperature indicator 213b is displayed on a second display 180b, and a second home screen 222b including a plurality of applications and a vehicle internal temperature indicator 213c is displayed on a third display 180c.

FIG. 4 is an internal block diagram illustrating an example of the vehicle display apparatus of FIG. 3B.

Referring to FIG. 4, a vehicle display apparatus 100 according to an embodiment of the present disclosure can include an input device 110, a transceiver 120 for communication with an external device, a plurality of communication modules EMa to EMd for internal communication, a memory 140, the signal processing device 170, a plurality of displays 180a to 180c, an audio output device 185, and a power supply 190.

The plurality of communication modules EMa to EMd can be disposed in a plurality of zones Z1 to Z4, respectively, in FIG. 2.

Meanwhile, the signal processing device 170 can be provided therein with a communication switch 736b for data communication with the respective communication modules EM1 to EM4.

The respective communication modules EM1 to EM4 can perform data communication with the plurality of sensor devices SN or the ECU 770 or a zonal signal processing device 170Z.

Meanwhile, a plurality of sensor devices SN can include a camera 195, a lidar sensor 196, a radar sensor 197, or a position sensor 198.

The input device 110 can include a physical button or pad for button input or touch input.

Meanwhile, the input device 110 can include a microphone (not shown) for user voice input.

The transceiver 120 can wirelessly exchange data with a mobile terminal 800 or a server 900.

In particular, the transceiver 120 can wirelessly exchange data with a mobile terminal of a vehicle driver. Any of various data communication schemes, such as Bluetooth, Wi-Fi, WIFI Direct, and APIX, can be used as a wireless data communication scheme.

The transceiver 120 can receive weather information and road traffic state information, such as Transport Protocol Experts Group (TPEG) information, from a mobile terminal 800 or a server 900. To this end, the transceiver 120 can include a mobile communication module (not shown).

The plurality of communication modules EM1 to EM4 can receive sensor data and the like from the electronic control unit (ECU) 770 or the sensor device SN or a zonal signal processing device 170Z, and can transmit the received sensor data to the signal processing device 170.

Here, the sensor data can include at least one of vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, or vehicle internal humidity data.

The sensor data can be acquired from a heading sensor, a yaw sensor, a gyro sensor, a position sensor, 2 vehicle forward/backward movement sensor, a wheel sensor, a vehicle speed sensor, a car body inclination sensor, a battery sensor, a fuel sensor, a tire sensor, a steering-wheel-rotation-based steering sensor, a vehicle internal temperature sensor, or a vehicle internal humidity sensor.

Meanwhile, the position module can include a GPS module configured to receive GPS information or a position sensor 198.

Meanwhile, at least one of the plurality of communication modules EM1 to EM4 can transmit position information data sensed by the GPS module or the position sensor 198 to the signal processing device 170.

Meanwhile, at least one of the plurality of communication modules EM1 to EM4 can receive front image data of the vehicle, side-of-vehicle image data, rear image data of the vehicle, and obstacle-around-vehicle distance information from the camera 195, the lidar sensor 196, or the radar sensor 197, etc., and can transmit the received information to the signal processing device 170.

The memory 140 can store various data necessary for overall operation of the vehicle display apparatus 100, such as programs for processing or control of the signal processing device 170.

For example, the memory 140 can store data about the hypervisor and first to third virtual machines executed by the hypervisor in the processor 175.

The audio output device 185 can convert an electrical signal from the signal processing device 170 into an audio signal, and can output the audio signal. To this end, the audio output device 185 can include a speaker.

The power supply 190 can supply: power necessary to operate components under control of the signal processing device 170. In particular, the power supply 190 can receive power from a battery in the vehicle.

The signal processing device 170 can control the overall operation of each device in the vehicle display apparatus 100.

For example, the signal processing device 170 can include a processor 175 configured to perform signal processing for the vehicle displays 180a and 180b.

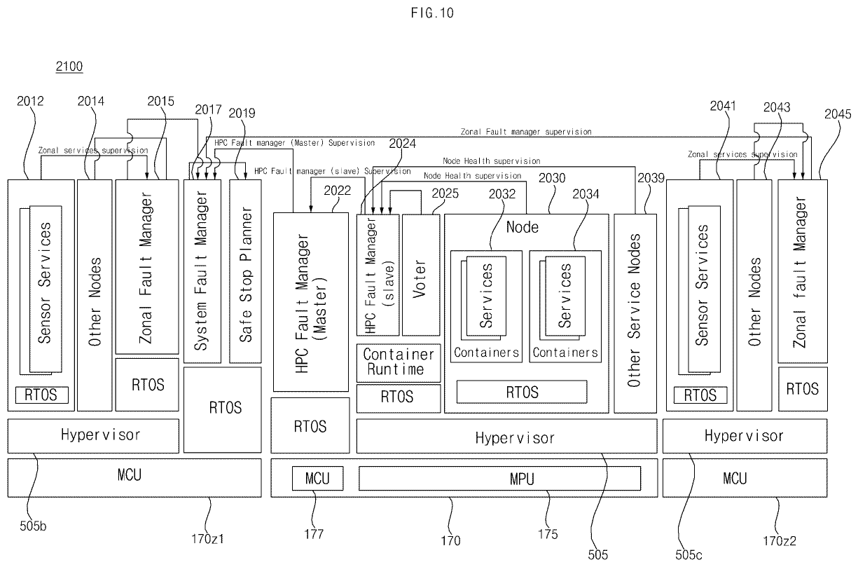

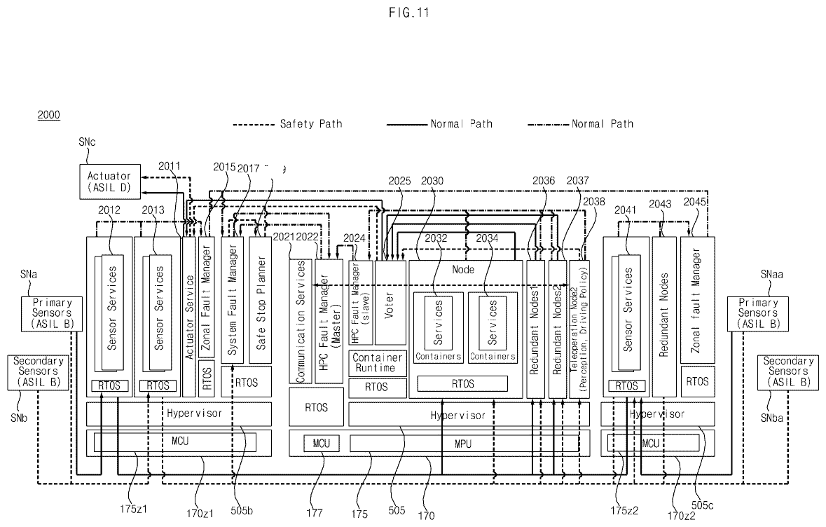

The processor 175 can execute the first to third virtual machines (not shown) on the hypervisor 505 (see FIG. 10) in the processor 175.

Among the first to third virtual machines (not shown) (see FIG. 10), the first virtual machine (not shown) can be called a server virtual machine, and the second and third virtual machines (not shown) and (not shown) can be called guest virtual machines.

For example, the first virtual machine (not shown) in the processor 175 can receive sensor data from the plurality of sensor devices, such as vehicle sensor data, position information data, camera image data, audio data, or touch input data, and can process and output the received sensor data.

As described above, the first virtual machine (not shown) can process most of the data, whereby 1:N data sharing can be achieved.

In another example, the first virtual machine (not shown) can directly receive and process CAN data, Ethernet data, audio data, radio data, USB data, and wireless communication data for the second and third virtual machines (not shown).

Further, the first virtual machine (not shown) can transmit the processed data to the second and third virtual machines (not shown).

Accordingly, only the first virtual machine (not shown), among the first to third virtual machines (not shown), can receive sensor data from the plurality of sensor devices, communication data, or external input data, and can perform signal processing, whereby load in signal processing by the other virtual machines can be reduced and 1:N data communication can be achieved, and therefore synchronization at the time of data sharing can be achieved.

Meanwhile, the first virtual machine (not shown) can be configured to write data in the shared memory 508, whereby the second virtual machine (not shown) and the third virtual machine (not shown) share the same data.

For example, the first virtual machine (not shown) can be configured to write vehicle sensor data, the position information data, the camera image data, or the touch input data in the shared memory 508, whereby the second virtual machine (not shown) and the third virtual machine (not shown) share the same data. Consequently, 1:N data sharing can be achieved.

Eventually, the first virtual machine (not shown) can process most of the data, whereby 1:N data sharing can be achieved.

Meanwhile, the first virtual machine (not shown) in the processor 175 can be configured to set the shared memory 508 based on the hypervisor 505 in order to transmit the same data to the second virtual machine (not shown) and the third virtual machine (not shown).

Meanwhile, the signal processing device 170 can process various signals, such as an audio signal, an image signal, and a data signal. To this end, the signal processing device 170 can be implemented in the form of a system on chip (SOC).

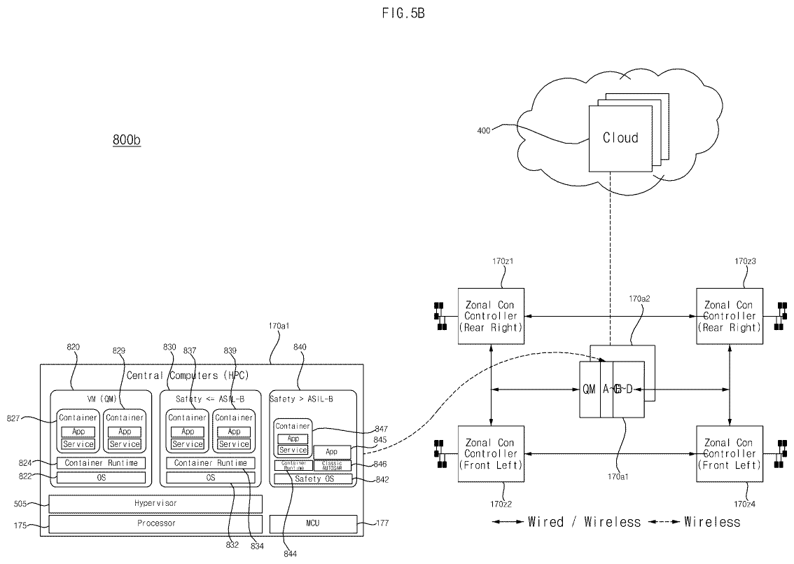

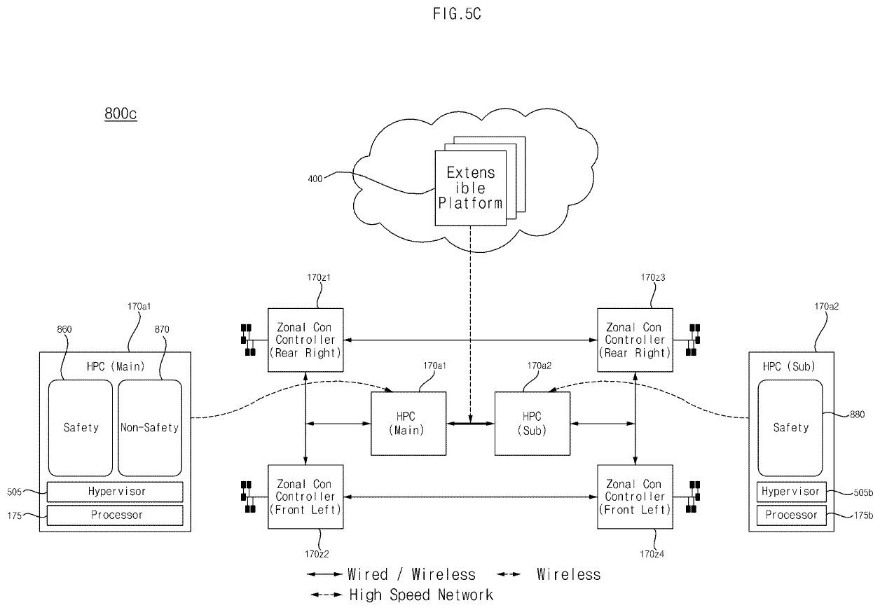

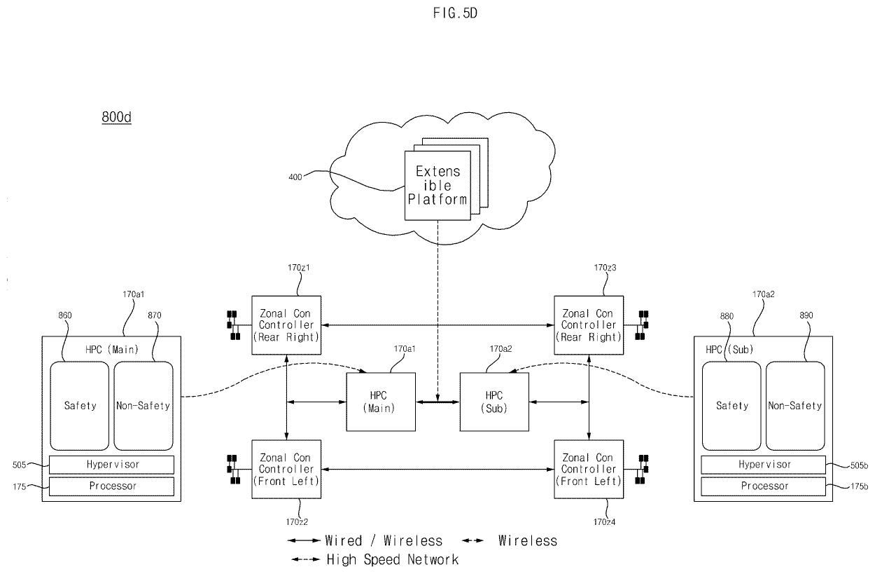

Meanwhile, the signal processing device 170 in the display apparatus 100 of FIG. 4 can be the same as signal processing devices 170, 170a1, and 170a2 of a vehicle display apparatus of FIG. 5A and subsequent figures.

FIGS. 5A to 5D are diagrams illustrating various examples of a vehicle display apparatus.

FIG. 5A is a diagram illustrating an example of a vehicle display apparatus according to an embodiment of the present disclosure.

Referring to FIG. 5A, a vehicle display apparatus 800a according to an embodiment the present disclosure includes signal processing devices 170a1 and 170a2 and a plurality of zonal signal processing devices 170Z1 to 170Z4.

Meanwhile, two signal processing devices 170a1 and 170a2 are illustrated in the figure, which are provided for backup and the like, and one signal processing device is also possible.

Meanwhile, the signal processing devices 170a1 and 170a2 can be referred to as a High Performance Computing (HPC) signal processing devices.

The plurality of zonal signal processing devices 170Z1 to 170Z4 can be located in the respective zones Z1 to Z4 and can transmit sensor data to the signal processing devices 170a1 and 170a2.

The signal processing devices 170a1 and 170a2 can receive data by wire from the plurality of zonal signal processing devices 170Z1 to 170Z4 or a communication device 120.

In the drawing, an example is illustrated in which the signal processing devices 170a1 and 170a2 exchange data with the plurality of zonal signal processing devices 170Z1 to 170Z4 based on wired communication, and the signal processing devices 170a1 and 170a2 exchange data with the server 400 based on wireless communication, but the communication device 120 can exchange data with the server 400 based on wireless communication, and the signal processing devices 170a1 and 170a2 can exchange data with the communication device 120 based on wired communication.

Meanwhile, the data received by the signal processing devices 170a1 and 170a2 can include camera data or sensor data.

For example, the vehicle internal sensor data can include at least one of vehicle wheel speed data, vehicle direction data, vehicle location data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, vehicle internal humidity data, external vehicle radar data or external vehicle lidar data.

Meanwhile, the camera data can include external vehicle camera data and vehicle internal camera data.

Meanwhile, the signal processing devices 170a1 and 170a2 can execute a plurality of virtual machines 820, 830, and 840 based on safety levels.

In the drawing, an example is illustrated in which the processor 175 in the signal processing device 170a executes the hypervisor 505, and execute first to third virtual machines 820 to 840 on the hypervisor 505 according to the Automotive Safety Integrity Level (ASIL).

The first virtual machine 820 can be a virtual machine corresponding to quality management (QM) which is the lowest risk level of the ASIL with no mandatory need.

The first virtual machine 820 can execute an operating system 822, a container runtime 824 on the operating system 822, and containers 827 and 829 on the container runtime 824.

The second virtual machine 820 can be a virtual machine corresponding to ASIL A or ASIL B with the combination of severity, exposure, and controllability values being 7 or 8.

The second virtual machine 820 can execute an operating system 832, a container runtime 834 on the operating system 832, and containers 837 and 839 on the container runtime 834.

The third virtual machine 840 can be a virtual machine corresponding to ASIL C or ASIL D with the combination of severity, exposure, and controllability values being 9 or 10.

Meanwhile, ASIL D can correspond to a grade that requires the highest level of safety.

The third virtual machine 840 can execute a safety operating system 842 and an application 845 on the operating system 842.

Meanwhile, the third virtual machine 840 can also execute the safety operating system 842, a container runtime 844 on the safety operating system 842, and a container 847 on the container runtime 844.

Meanwhile, unlike the drawing, the third virtual machine 840 can also be executed by a separate core, rather than by the processor 175, which will be described below with reference to FIG. 5B.

FIG. 5B is a diagram illustrating another example of a vehicle display apparatus according to an embodiment of the present disclosure.

Referring to FIG. 5B, a vehicle display apparatus 800b according to an embodiment of the present disclosure includes signal processing devices 170a1 and 170a2 and a plurality of zonal signal processing devices 170Z1 to 170Z4.

The vehicle display apparatus 800b of FIG. 5B is similar to the vehicle display apparatus 800a of FIG. 5A, with a difference being that the signal processing device 170a1 of FIG. 5B is partially different from the signal processing device 170a1 of FIG. 5A.

The following description will focus on the difference, in which the signal processing device 170a can include a processor 175 and a second processor 177.

The processor 175 in the signal processing device 170a1 is configured to execute the hypervisor 505, and execute the first and second virtual machines 820 and 830 on the hypervisor 505 according to the ASIL.

The first virtual machine 820 can execute the operating system 822, the container runtime 824 on the operating system 822, and the containers 827 and 829 on the container runtime 824.

The second virtual machine 820 can execute the operating system 832, the container runtime 834 on the operating system 832, and the containers 837 and 839 on the container runtime 834.

Meanwhile, the second processor 177 in the signal processing device 170a1 can execute the third virtual machine 840.

The third virtual machine 840 can execute the safety operating system 842, an AUTOSAR 845 on the operating system 842, and an application 845 on the AUTOSAR 845. That is, unlike FIG. 5A, the third virtual machine 840 can further execute the AUTOSAR 846 on the operating system 842.

Meanwhile, similarly to FIG. 5A, the third virtual machine 840 can also execute the safety operating system 842, the container runtime 844 on the safety operating system 842, and the container 847 on the container runtime 844.

Meanwhile, unlike the first and second virtual machines 820 and 830, the third virtual machine 840 that requires a high safety level is desirably executed by the second processor 177 that is a different core or a different processor.

Meanwhile, in the signal processing devices 170a1 and 170a2 of FIGS. 5A and 5B, if there is abnormality in the first signal processing device 170a, the second signal processing device 170a can operate which is provided for backup purposes.

Unlike the example, the signal processing devices 170a1 and 170a2 can operate at the same time, among which the first signal processing device 170a can operate as a main device, and the second signal processing device 170a2 can operate as a sub device, which will be described below with reference to FIGS. 5C and 5D.

FIG. 5C is a diagram illustrating yet another example of a vehicle display apparatus according to an embodiment of the present disclosure.

Referring to FIG. 5C, a vehicle display apparatus 800c according to an embodiment of the present disclosure includes signal processing devices 170a1 and 170a2 and a plurality of zonal signal processing devices 170Z1 to 170Z4.

Meanwhile, two signal processing devices 170a1 and 170a2 are illustrated in the figure, which are provided for backup and the like, and one signal processing device is also possible.

Meanwhile, the signal processing devices 170a1 and 170a2 can be referred to as a High Performance Computing (HPC) signal processing devices.

The plurality of zonal signal processing devices 170Z1 to 170Z4 can be located in the respective zones Z1 to Z4 and can transmit sensor data to the signal processing devices 170a1 and 170a2.

The signal processing devices 170a1 and 170a2 can receive data by wire from the plurality of zonal signal processing devices 170Z1 to 170Z4 or a communication device 120.

In the drawing, an example is illustrated in which the signal processing devices 170a1 and 170a2 exchange data with the plurality of zonal signal processing devices 170Z1 to 170Z4 based on wired communication, and the signal processing devices 170a1 and 170a2 exchange data with the server 400 based on wireless communication, but the communication device 120 can exchange data with the server 400 based on wireless communication, and the signal processing devices 170a1 and 170a2 exchange data with the communication device 120 based on wired communication.

Meanwhile, the data received by the signal processing devices 170a1 and 170a2 can include camera data or sensor data.

Meanwhile, the processor 175 in the first signal processing device 170a1 of the signal processing devices 170a1 and 170a2 can execute the hypervisor 505, and can execute each of a safety virtual machine 860 and a non-safety virtual machine 870 on the hypervisor 505.

Meanwhile, the processor 175b in the second signal processing device 170a2 of the signal processing devices 170a1 and 170a2 can execute the hypervisor 505b, and can execute only a safety virtual machine 880 on the hypervisor 505.

In the method, safety and non-safety virtual machines can be processed separately by the first signal processing device 170a1 and the second signal processing device 170a2, thereby improving stability and processing speed.

Meanwhile, high-speed network communication can be performed between the first signal processing device 170a1 and the second signal processing device 170a2.

FIG. 5D is a diagram illustrating yet another example of a vehicle display apparatus according to an embodiment of the present disclosure.

Referring to FIG. 5D, a vehicle display apparatus 800d according to an embodiment of the present disclosure includes signal processing devices 170a1 and 170a2 and a plurality of zonal signal processing devices 170Z1 to 170Z4.

The vehicle display apparatus 800d of FIG. 5D is similar to the vehicle display apparatus 800c of FIG. 5C, with a difference being that the second signal processing device 170a2 of FIG. 5D is partially different from the second signal processing device 170a2 of FIG. 5C.

The processor 175b in the second signal processing device 170a2 of FIG. 5D can execute the hypervisor 505b, and can execute each of a safety virtual machine 880 and a non-safety virtual machine 890 on the hypervisor 505.

That is, unlike FIG. 5C, there is a difference in that the processor 175b in the second signal processing device 170a2 is further configured to execute the non-safety virtual machine 890.

In the method, safety and non-safety virtual machines can be processed separately by the first signal processing device 170a1 and the second signal processing device 170a2, thereby improving stability and processing speed.

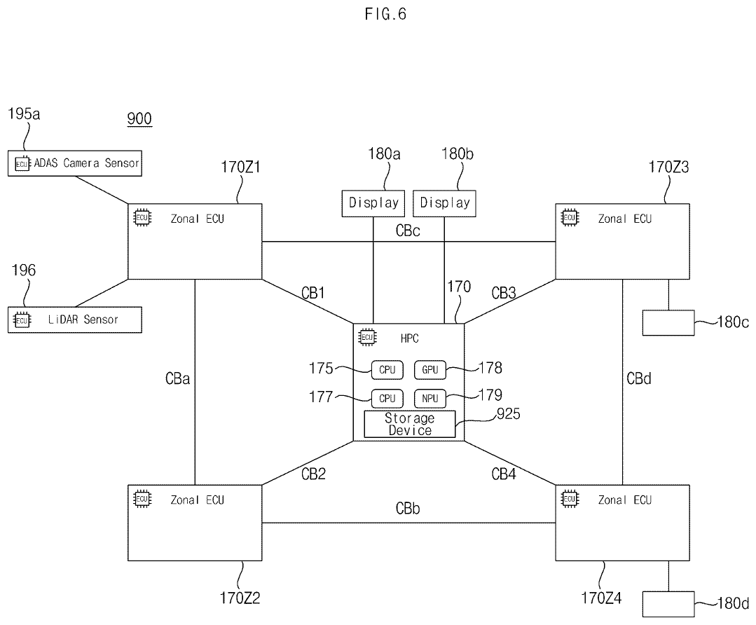

FIG. 6 is an exemplary block diagram of a vehicle display apparatus according to an embodiment of the present disclosure.

Referring to FIG. 6, a vehicle display apparatus 900 according to an embodiment of the present disclosure includes the signal processing device 170 and at least one display.

In the drawing, a cluster display 180a, an audio video navigation (AVN) display 180b, and network displays 180c and 180d are illustrated as the at least one display.

Meanwhile, the cluster display 180a and the AVN display 180b can be respectively connected to display ports.

Meanwhile, the network displays 180c and 180d can be connected to an in-vehicle network via respective network ports. The network in this case can be an Ethernet network which is based on Ethernet communication.

Although, in the drawing, the network displays 180c and 180d are illustrated as being respectively connected to the third zonal signal processing device 170Z3 and the fourth zonal signal processing apparatus 170Z4, they can be connected to other zonal signal processing devices or be immediately connected to the signal processing device 170.

Meanwhile, the vehicle display apparatus 900 can further include the plurality of zonal signal processing devices 170Z1 to 170Z4.

In this case, the signal processing device 170 is a high-performance centralized signal processing and control device including a plurality of CPUs 175, GPUS 178, NPUS 179, etc., and can be referred to as a High Performance Computing (HPC) signal processing device or a central signal processing device.

The plurality of zonal signal processing devices 170Z1 to 170Z4 and the signal processing device 170 can be connected via wired cables CB1 to CB4.

Meanwhile, the plurality of zonal signal processing devices 170Z1 to 170Z4 can be connected via wired cables CBa to CBd.

In this case, the wired cables CBa to CBd can include CAN communication cable or Ethernet communication cable, or PCI Express cable.

Meanwhile, the signal processing device 170 according to an embodiment of the present disclosure can include at least one processor 175, 178, and 177, and a storage device 925 having a large capacity.

For example, the signal processing device 170 according to an embodiment of the present disclosure can include central processors 175 and 177, a graphic processor 178, and a neural processor 179.

Meanwhile, sensor data can be transmitted from at least one of the plurality of zonal signal processing devices 170Z1 to 17024 to the signal processing device 170. Particularly, the sensor data can be stored in the storage device 925 in the signal processing device 170.

In this case, the sensor data can include at least one of camera data, lidar data, radar data, vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data or vehicle internal humidity data.

In the drawing, an example is illustrated in which the camera data from the camera 195a and the lidar data from the lidar sensor 196 are input to a first zonal signal processing device 170Z1, and the camera data and the lidar data are transmitted to the signal processing device 170 via a second zonal signal processing device 170Z2 and a third zonal signal processing device 170Z3, and the like.

Meanwhile, data write speed or data read speed to write and read data to and from the storage device 925 is faster than a network speed when the sensor data is transmitted from at least one of the plurality of zonal signal processing devices 170Z1 to 170Z4 to the signal processing device 170, such that it is preferred to perform multi path routing so as to avoid bottlenecks in a network.

To this end, the signal processing device 170 according to an embodiment of the present disclosure can perform multi path routing based on Software Defined Network (SDN). Accordingly, stable network environment for data write and read operations can be ensured. Further, data can be transmitted to the storage device 925 by using multiple paths, such that data can be transmitted by dynamically changing a network configuration.

It is desirable that data communication between the plurality of zonal signal processing devices 170Z1 to 170Z4 and the signal processing device 170 in the vehicle display apparatus 900 according to an embodiment of the present disclosure is peripheral component interconnect express communication in order to provide high band and low delay communication.

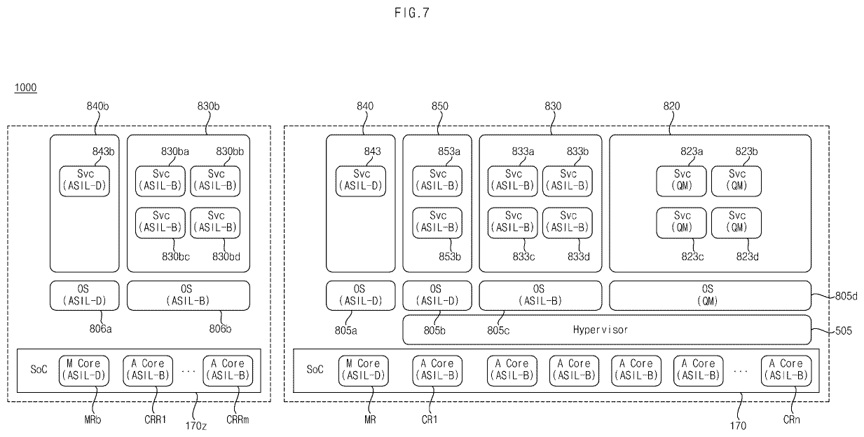

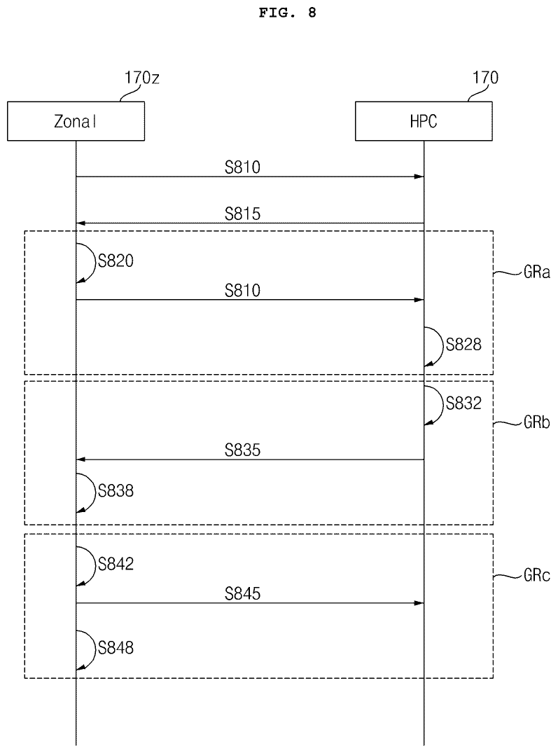

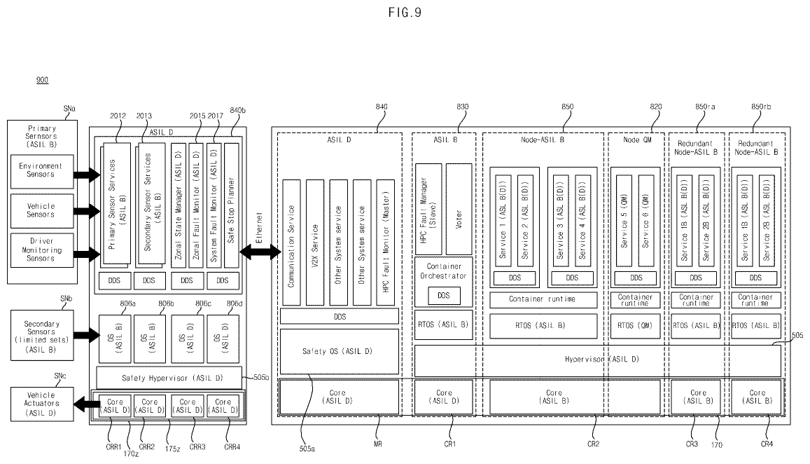

FIG. 7 is an exemplary internal block diagram of a signal processing device according to an embodiment of the present disclosure

Referring to FIG. 7, a signal processing system 1000 according to an embodiment of the present disclosure can include a central signal processing device 170 and a zonal signal processing device 170z.

Meanwhile, the signal processing device 170 in the system 1000 according to an embodiment of the present disclosure includes a plurality of processor cores CR1 to CRn and MR.

Meanwhile, some processor cores CR1 to CRn among the plurality of processor cores CR1 to CRn and MR can correspond to processor cores in the central processor CPU of FIG. 6.

For example, some processor cores CR1 to CRn among the plurality of processor cores CR1 to CRn and MR can correspond to application processor cores in the central processor CPU of FIG. 6.

Meanwhile, some processor cores CR1 to CRn among the plurality of processor cores CR1 to CRn and MR can operate based on the hypervisor 505, and the hypervisor 505 can execute the plurality of virtual machines 820 to 850.

Meanwhile, another processor core MR among the plurality of processor cores CR1 to CRn and MR can correspond to M core or micom unit (MCU).

Meanwhile, another processor core MR among the plurality of processor cores CR1 to CRn and MR can execute an operating system 805a corresponding to the second safety level such as ASIL D, without executing the hypervisor 505, and can execute a fourth virtual machine 840 on the operating system 805a.

Meanwhile, the fourth virtual machine 840 can execute an application corresponding to the second safety level such as ASIL D or a microservice 843 corresponding to the application corresponding to the second safety level. Accordingly, the microservice 843 or the application corresponding to the second safety level can be stably executed.

Meanwhile, a first processor core CR1 among the plurality of processor cores CR1 to CRn and MR can execute the hypervisor 505, can execute the operating system 805b, corresponding to the second safety level such as ASIL D, on the hypervisor 505, and can execute the first virtual machine 850 on the operating system 805b.

Meanwhile, the first virtual machine 850 can execute an application corresponding to the first safety level such as ASIL B or microservices 853a and 853b corresponding to the application corresponding to the first safety level. Accordingly, the microservices 853a and 853b or the application corresponding to the first level safety can be stably executed.

Meanwhile, unlike the drawing, the first processor core CR1 among the plurality of processor cores CR1 to CRn and MR can execute an operating system, corresponding to the first safety level such as ASIL B, on the hypervisor 505.

Meanwhile, the second processor core CR2 and the third processor core CR3 among the plurality of processor cores CR1 to CRn and MR can execute the hypervisor 505, can execute the operating system 805c, corresponding to the first safety level such as ASIL B, on the hypervisor 505, and can execute the second virtual machine 850 on the operating system 805c.

Meanwhile, the second virtual machine 850 can execute a third application corresponding to the first safety level such as ASIL B or microservices 833a to 833d corresponding to the third application corresponding to the first safety level. Accordingly, the microservices 833a to 833d or the application corresponding to the first safety level can be stably executed.

Meanwhile, the remaining processor cores CR4 to CRn among the plurality of processor cores CR1 to CRn and MR can execute the hypervisor 505, can execute the operating system 805d, corresponding to the third safety level such as QM, on the hypervisor 505, and can execute the third virtual machine 820 on the operating system 805d.

Meanwhile, the third virtual machine 820 can execute a fourth application corresponding to the third safety level such as QM or microservices 823a to 823d corresponding to the fourth application corresponding to the third safety level, on the operating system 805d that corresponds to the third safety level lower than the first safety level. Accordingly, the microservices 823a to 823d or the application corresponding to the third safety level can be stably executed.

Meanwhile, the zonal signal processing device 170z can include a plurality of application processor cores CRR1 to CRRm, and an M-core MRb for executing an application corresponding to the second safety level, such as ASIL D, which is the highest level of safety.

Meanwhile, some processor cores RR1 to CRRm among the plurality of processor cores CRR1 to CRRm in the zonal signal processing device 170z can execute an operating system 806b corresponding to the first safety level such as ASIL B, and can execute the virtual machine 830b, corresponding to the first safety level, on the operating system 806a.

Meanwhile, the virtual machine 830b corresponding to the first safety level can execute the application corresponding to the first safety level such as ASIL B, or microservices 830ba to 830bd corresponding to the application corresponding to the first safety level. Accordingly, the microservices 830ba to 830bd or the application corresponding to the first safety level can be stably executed.

Meanwhile, another processor core MRb among the plurality of processor cores CRR1 to CRRm and MRb in the zonal signal processing device 170z can execute an operating system 806a corresponding to the second safety level such as ASIL D, and can execute the virtual machine 840b, corresponding to the second safety level such as ASIL D, on the operating system 806a.

Meanwhile, the virtual machine 840b corresponding to the second safety level can execute the application corresponding to the second safety level such as ASIL D, or a microservice 843b corresponding to the application corresponding to the second safety level. Accordingly, the microservice 843b or the application corresponding to the second safety level can be stably executed.

FIG. 8 is a flowchart illustrating a method of operating a vehicle display apparatus according to an embodiment of the present disclosure.

Referring to the drawing, in a normal mode, a processor (175z of FIG. 9) in a zonal signal processing device 170z is configured to transmit sensor data received from a sensor device SN or camera data received from a camera 195 to the central signal processing device 170 (S810).

Accordingly, the zonal signal processing device 170z transmits the sensor data or camera data from the connected sensor device SN or camera 195 to the central signal processing device 170.

In this case, the sensor data can include at least one of vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, vehicle internal humidity data, road surface humidity data, emergency vehicle sensing data, ultrasonic sensor data, LiDAR data, and radar data.

In this case, the camera data can include external vehicle camera data and vehicle internal camera data.

Meanwhile, in the normal mode, the central signal processing device 170 can be configured to output an image signal to the display 180, based on received sensor data or camera data.

For example, in the normal mode, the central signal processing device 170 can be configured to display speed information on the cluster display 180a or a vehicle front image is displayed on the AVN display 180b, based on received sensor data or camera data.

Specifically, in the normal mode, the received sensor data or camera data can include data on a vehicle ahead, a pedestrian or obstacle ahead, etc.

Meanwhile, in the normal mode, the central signal processing device 170 can be configured to generate a control signal and transmit the generated control signal to the zonal signal processing device 170z, based on the received sensor data or camera data (S815).

For example, in the normal mode, the processor 175 in the central signal processing device 170 can be configured to generate and output a control signal for laterally or longitudinally controlling vehicle driving or for accelerating or decelerating the vehicle, based on received data on a vehicle ahead, a pedestrian or obstacle ahead, etc.

Meanwhile, in the normal mode, the processor 175z in the zonal signal processing device 170z can be configured to operate the sensor device SN or the camera 195 or an actuator (SNc of FIG. 9), based on a control signal received based on transmission of the sensor data or the camera data. Accordingly, it is possible to stably perform vehicle driving in the normal mode.

For example, the processor 175z in the zonal signal processing device 170z can laterally control vehicle driving, based on a received control signal.

Next in response to the amount of the sensor data or camera data being at or below a first reference value during the normal mode, the processor 175z in the zonal signal processing device 170z can be configured to determine that the performance of the sensor device SN or the camera 195 has degraded and generate performance degradation information or degradation mode initiation information (S820).

Also, the processor 175z in the zonal signal processing device 170z can be configured to transmit the generated performance degradation information or degradation mode initiation information to the central signal processing device 170.

Meanwhile, in response to receiving the performance degradation information or degradation information initiation from the zonal signal processing device 170z, the processor 175 in the central signal processing device 170 is configured to perform the degradation mode (S828).

For example in response to the amount of the sensor data or camera data received being at or below the first reference value during the normal mode, the processor 175z in the zonal signal processing device 170z can be configured to transmit second sensor data or second camera data received from another sensor device SN or camera 195 different from the sensor device SN or camera 195 to the central signal processing device 170.

In response to this, in response to receiving second sensor data or second camera data received from an auxiliary sensor device SNb or auxiliary camera different from a main sensor device SNa or main camera 195, after receiving the performance degradation information or degradation mode initiation information from the zonal signal processing device 170z, the processor 175 in the central signal processing device 170 can be configured to enable the degradation mode, based on the second sensor data or the second camera data.

In this case, the second sensor data or the second camera data can be lower in data amount or in resolution than main sensor data or main camera data from the main sensor device SNa or main camera 195.

Meanwhile, the processor 175 in the central signal processing device 170 can be configured to generate and output a second control signal according to the degradation mode.

Meanwhile, the processor 175z in the zonal signal processing device 170z can be configured to operate the sensor device SN or the camera 195 or the actuator (SNc of FIG. 9) by the second control signal generated in the degradation mode.

In this case, it is preferred that the control in the degradation mode is performed more stably than the control in the normal mode.

For example, in the degradation mode, the processor 175z in the zonal signal processing device 170z can be configured to perform the lateral or longitudinal control of vehicle driving or the acceleration of the vehicle less than in the normal mode. Accordingly, it is possible to stably perform vehicle driving in the degradation mode.

In another example, in the degradation mode, the processor 175z in the zonal signal processing device 170z can be configured to decelerate the vehicle more than in the normal mode. Accordingly, it is possible to stably perform vehicle driving in the degradation mode.

Next, in response of a failure of the central signal processing device 170 or the processor 175 of the central signal processing device 170, the central signal processing device 170 can be configured to generate failure information (S832) and transmit the failure information to the zonal signal processing device 170z (S835).

In response to this, the processor 175z in the zonal signal processing device 170z can be configured to receive the failure information of the central signal processing device 170 and an emergency mode based on the received failure information (S838).

For example, based on the emergency mode, part of the operation of the central signal processing device 170 can be replaced by the zonal signal processing device 170z.

Specifically, based on the emergency mode, a driving-related application to be executed by the central signal processing device 170 can be executed by the zonal signal processing device 170z instead. Accordingly, it is possible to stably perform vehicle driving in the emergency mode.

Next, the processor 175z in the zonal signal processing device 170z can check for a failure of the sensor device SN or the camera 195 (S842), and in response of a failure, can be configured to transmit failure information or emergency mode initiation information to the central signal processing device 170 (S845).

Also, the processor 175z in the zonal signal processing device 170z can perform the emergency mode (S848).

For example, if the amount of the sensor data or camera data received from the sensor device SN or the camera 195 is at or below a second reference value which is lower than the first reference value, the processor 175z in the zonal signal processing device 170z can be configured to determine that the sensor device SN or the camera 195 has a failure and perform the emergency mode. Accordingly, it is possible to stably perform vehicle driving in the emergency mode.

Meanwhile, in the emergency mode, the processor 175z can be configured to transmit failure information or emergency mode initiation information to the central signal processing device 170. Accordingly, it is possible to stably perform vehicle driving in the emergency mode.

For example, in response of a failure of the sensor device SN or the camera 195, the processor 175z in the zonal signal processing device 170z can be configured to perform safe stop based on the emergency mode. Accordingly, vehicle safety can be promoted.

FIG. 9 is a block diagram illustrating another example of a vehicle display apparatus according to an embodiment of the present disclosure.

Referring to the drawing, the vehicle display apparatus 900 according to the embodiment of the present disclosure includes at least one display 180, a zonal signal processing device 170z configured to receive sensor data or camera data from a sensor device SN or a camera 195, and a central signal processing device 170 configured to output an image signal to the display, based on the sensor data or the camera data.

Meanwhile, the zonal signal processing device 170z according to the embodiment of the present disclosure includes a processor 175z that, in a normal mode, is configured to transmit sensor data received from a sensor device SN or camera data received from a camera 195 to the central signal processing device 170.

Meanwhile, the processor 175z in the zonal signal processing device 170z is configured to perform the emergency mode, in response of a failure of the central signal processing device 170 or the sensor device SN or the camera 195.

Meanwhile, the processor 175z can include a plurality of processor cores CRR1 to CRR4. Although the drawing illustrates a plurality of processor cores CRR1 to CRR4 corresponding to ASIL D, various modifications are possible.

Meanwhile, the processor 175z can be configured to execute a hypervisor 505b and execute a zonal fault manager 2015 on the hypervisor 505b.

Meanwhile, the processor 175z can be further configured to execute sensor services 2012 and 2013 on the hypervisor 505b for transmitting the sensor data or the camera data.

In this case, the safety level of the zonal fault manager 2015 can be higher than the safety level of the sensor services 2012 and 2013.

The drawing illustrates that the safety level of the zonal fault manager 2015 is ASIL D which is higher than ASIL B, the safety level of the sensor services. Accordingly, it is possible to stably perform vehicle driving.

Meanwhile, the processor 175z can be further configured to execute a system fault manager 2017 on the hypervisor 505b.

Meanwhile, the system fault manager 2017 can be configured to generate a diagnosis result log based on diagnosis result data received from the central signal processing device 170.

In this case, the safety level of the zonal fault manager 2015 and the safety level of the system fault manager 2017 can be the same, i.e., ASIL D.

The drawing illustrates that the hypervisor 505b is executed on the plurality of processor cores CRR1 to CRR4 in the zonal signal processing device 170z, and that a plurality of operating systems 806a to 806d are executed on the hypervisor 505b.

In this case, the plurality of operating systems 806a to 806d can include operating systems 806a and 806b corresponding to the first safety level, ASIL B, and operating systems 806c and 806d corresponding to the second safety level, ASIL D, which is higher than the first safety level.

Meanwhile, a main sensor service (2012 of FIG. 11) for receiving sensor data from main sensor devices SNa and an auxiliary sensor service (2013 of FIG. 11) for receiving sensor data from auxiliary sensor devices SNb can be executed on an operating system corresponding the first safety level, ASIL B.

Meanwhile, the main sensor devices SNa can include environmental sensors, vehicle sensors, and driver monitoring sensors.

Meanwhile, the processor 175z can be configured to operate the sensor device SN or the camera 195 or an actuator SNc, based on a control signal received based on transmission of the sensor data or the camera data.

Meanwhile, the safety level of the actuator SNc can be higher than the safety level of the sensor device SN or the camera 195.

For example, as shown in the drawing, the safety level of the sensor device SN or the camera 195 can correspond to ASIL B corresponding to the first safety level, and the safety level of the actuator SNc can correspond to ASIL D corresponding g to the second safety level which is higher than the first safety level.

Meanwhile, the processor 175z can be configured to execute the hypervisor 505b and execute the virtual machine 840b on the hypervisor 505b.

Meanwhile, the virtual machine 840b can be configured to execute the zonal fault manager 2015, the system fault manager 2017, and the sensor services 2012 and 2013 for transmitting sensor data or camera data.

The central signal processing device 170 includes a processor 175 configured to execute an application for driving the vehicle, based on sensor data or camera data received from the zonal signal processing device 170z.

Meanwhile, in response to receiving performance degradation information or degradation mode initiation information from the zonal signal processing device 170z, the processor 175 is configured to perform the degradation mode. Accordingly, it is possible to stably perform vehicle driving. In particular, it is possible to stably perform vehicle driving in the degradation mode.

Meanwhile, the processor 175 can be configured to transmit diagnosis result data of the sensor data or camera data to the zonal signal processing device 170z, based on sensor data or camera data received from the zonal signal processing device 170z. Accordingly, it is possible to stably perform vehicle driving.

Meanwhile, the processor 175 can be configured to execute a hypervisor 505 and execute a plurality of virtual machines 820, 830, 850, 850ra, and 850rb on the hypervisor 505.

Meanwhile, the processor 175 can include a plurality of processor cores MR and CR1 to CR4.

Meanwhile, the M core MR, among the plurality of processor cores MR and CR1 to CR4, can be configured to execute a safety operating system and execute a communication service, a V2X service, a system service, a fault monitor, etc. on the safety operating system.

Meanwhile, the M core MR can be configured to execute the safety operating system and execute a virtual machine 840 corresponding to the second safety level, ASIL D, on the safety operating system.

Meanwhile, the first core CR1, among the plurality of processor cores MR and CR1 to CR4, can be configured to execute a virtual machine 830 corresponding to the first safety level, ASIL B.

In particular, the virtual machine 830 can be configured to execute a fault manager, a container orchestrator, etc.

Meanwhile, the second core CR2, among the plurality of processor cores MR and CR1 to CR4, can be configured to execute a virtual machine 850 corresponding to the first safety level, ASIL B, and a virtual machine 820 corresponding to the third safety level, QM.

Meanwhile, the virtual machine 850 can be configured to execute a service corresponding to the first safety level, ASIL B.

Meanwhile, the virtual machine 820 can be configured to execute a service corresponding to the third safety level, QM.

Meanwhile, the third core CR3, among the plurality of processor cores MR and CR1 to CR4, can be configured to execute a redundant virtual machine 850ra corresponding to the first safety level, ASIL B.

Meanwhile, the fourth core CR4, among the plurality of processor cores MR and CR1 to CR4, can be configured to execute a redundant virtual machine 850rb corresponding to the first safety level ASIL B.

FIG. 10 is a block diagram illustrating yet another example of a vehicle display apparatus according to an embodiment of the present disclosure.

Referring to the drawing, a vehicle display apparatus 2000 according to an embodiment of the present disclosure includes a central signal processing device 170 and a plurality of zonal signal processing devices 170z1 and 170z2.

Meanwhile, the central signal processing device 170 can include a processor 175 including an application processor core, and a second processor 177 including an M core.

Meanwhile, the second processor 177 can execute a real time operating system (RTOS), and can execute a master fault manager 2022 on the RTOS.

In this case, the fault manager 202 can be executed without the hypervisor 505.

Meanwhile, the processor 175 can execute the hypervisor 505, execute the RTOS on a part of the hypervisor 505, execute a container runtime on the RTOS, and execute a slave fault manager 2024 and a voter 2025 on the container runtime.

Meanwhile, the processor 175 can execute the RTOS on another part of the hypervisor 505 and execute a node 2030, including containers 2032 and 2034, on the RTOS.

Meanwhile, the processor 175 can execute another service node 2039 on yet another part Of the hypervisor 505.

Meanwhile, the first zonal signal processing device 170z1 can execute a hypervisor 505b, execute the RTOS on a part of the hypervisor 505b, and execute a sensor service 2012 on the RTOS.

Meanwhile, the first zonal signal processing device 170z1 can execute another node 2014 on another part of the hypervisor 505.

Meanwhile, the first zonal signal processing device 170z1 can execute the RTOS on yet another part of the hypervisor 505b, and can execute a fault manager 2015 on the RTOS.

Meanwhile, the first zonal signal processing device 170z1 can execute the RTOS on yet another part of the hypervisor 505b, and can execute a system fault manager 2017 and a safe stop planner 2019 on the RTOS.

Meanwhile, the second zonal signal processing device 170z2 can execute a hypervisor 505c, execute the RTOS on a part of the hypervisor 505c, and execute a sensor service 2041 on the RTOS.

Meanwhile, the second zonal signal processing device 170z2 can execute another node 2043 on another part of the hypervisor 505c.

Meanwhile, the second zonal signal processing device 170z2 can execute the RTOS on yet another part of the hypervisor 505c, and can execute a fault manager 2045 on the RTOS.

Meanwhile, in response to a fault occurring in the central signal processing device 170, a slave fault manager 2024 receives fault information, and the slave fault manager 2024 can transmit the fault information to a master fault manager 2022.

Meanwhile, the master fault manager 2022 can transmit the fault information of the central signal processing device 170 to a system fault manager 2019 in the first zonal signal processing device 170z1.

Meanwhile, the zonal fault manager 2015 in the first zonal signal processing device 170z1 can receive the fault information from the sensor service 2012 and can transmit the fault information to the system fault manager 2019.

Meanwhile, the zonal fault manager 2045 in the second zonal signal processing device 170z2 can receive the fault information from the sensor service 2041 and can transmit the fault information to the system fault manager 2019 in the first zonal signal processing device 170z1.

Accordingly, the system fault manager 2019 in the first zonal signal processing device 170z1 can integrate and manage the fault information.

Meanwhile, unlike the drawing, the system fault manager 2019 can also be included in the central signal processing device 170, rather than in the zonal signal processing device 170z1.

FIG. 11 is a block diagram illustrating a further example of a vehicle display apparatus according to an embodiment of the present disclosure.

Referring to the drawing, a vehicle display apparatus 2000 according to an embodiment of the present disclosure includes a central signal processing device 170 and a plurality of zonal signal processing devices 170z1 and 170z2.

Meanwhile, the central signal processing device 170 can include a processor 175 including an application processor core, and a second processor 177 including an M core.

Meanwhile, the second processor 177 can execute a real time operating system (RTOS), and can execute communication services 2121 and a fault manager 2022 on the RTOS.

Meanwhile, the processor 175 can execute the hypervisor 505, execute the RTOS on a part of the hypervisor 505, execute a container runtime on the RTOS, and execute a fault manager 2024 and a voter 2025 on the container runtime.

Meanwhile, the processor 175 can execute the RTOS on another part of the hypervisor 505 and execute a node 2030 including containers 2032 and 2034 on the RTOS.

Meanwhile, the processor 175 can execute a redundant node 1 2036, a redundant node 2 2037, and a teleoperation node 2038 on yet another part of the hypervisor 505.

Meanwhile, the first zonal signal processing device 170z1 can include a processor.

Meanwhile, the first zonal signal processing device 170z1 can execute a hypervisor 505b, can execute the RTOS on another part of the hypervisor 505b, and can execute sensor services 2012 and 2013 on the RTOS.

Meanwhile, the first zonal signal processing device 170z1 can execute an actuator service 2011.

Meanwhile, the first zonal signal processing device 170z1 can execute the RTOS on another part of the hypervisor 505b, and can execute a fault manager 2015 on the RTOS.

Meanwhile, the first zonal signal processing device 170z1 can execute the RTOS on yet another part of the hypervisor 505b, and can execute a system fault manager 2017 and a safe stop planner 2019 on the RTOS.

Meanwhile, a first sensor service 2012 can receive sensor data from a main sensor device SNa through a normal path, and can transmit the received sensor data to the central signal processing device 170 or the second zonal signal processing device 170z2 through the normal path.

Meanwhile, a second sensor service 2013 can receive sensor data from main sensor devices SNa or auxiliary sensor devices SNb through a safety path, and can transmit the received sensor data to the central signal processing device 170 or the second zonal signal processing device 170z2 through the safety path.

Meanwhile, the actuator service 2011 can control an actuator SNc through the normal path or the safety path.

Meanwhile, the second zonal signal processing device 170z2 can include a processor.

Meanwhile, the second zonal signal processing device 170z2 can execute a hypervisor 505c, can execute the RTOS on a part of the hypervisor 505c, and can execute a sensor service 2041 on the RTOS.

Meanwhile, the second zonal signal processing device 170z2 can execute a redundant node 2044.

Meanwhile, the second zonal signal processing device 170z2 can execute the RTOS on another part of the hypervisor 505c, and can execute a fault manager 2045 on the RTOS.

Meanwhile, the sensor service 2041 can receive sensor data from a main sensor device SNaa through a normal path, and can transmit the received sensor data to the central signal processing device 170 or the first zonal signal processing device 170z1 through the normal path.

Meanwhile, the sensor service 2041 can receive sensor data from main sensor devices SNaa or auxiliary sensor devices SNba a through a safety path, and can transmit the received sensor data to the central signal processing device 170 or the first zonal signal processing device 170z1 through the safety path.

Meanwhile, as in FIG. 9, the processor 175 can be configured to execute a plurality of virtual machines 820, 830, 850, 850ra, and 850rb on the hypervisor 505, and any one of 820, 830, 850, 850ra, and 850rb can be configured to execute the fault manager 2024.

Meanwhile, the processor 175 can be configured to execute a second fault manager 2022, without executing the hypervisor 505, and the safety level of the second fault manager 2022 can be higher than the safety level of the fault manager 2024 executed on the hypervisor 505.

For example, the fault manager 2024 can be executed on the virtual machine 820 of ASIL B corresponding to the first safety level, and the second fault manager 2022 can be executed on the virtual machine 840 of ASIL D corresponding to the second safety level which is higher than the first safety level. Accordingly, it is possible to stably perform vehicle driving.

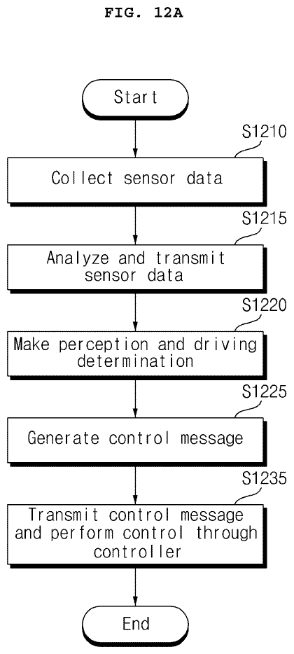

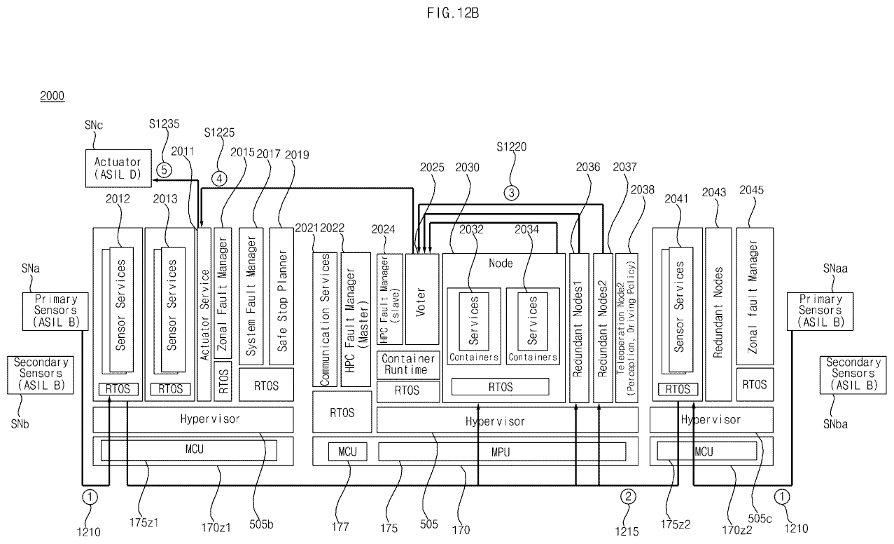

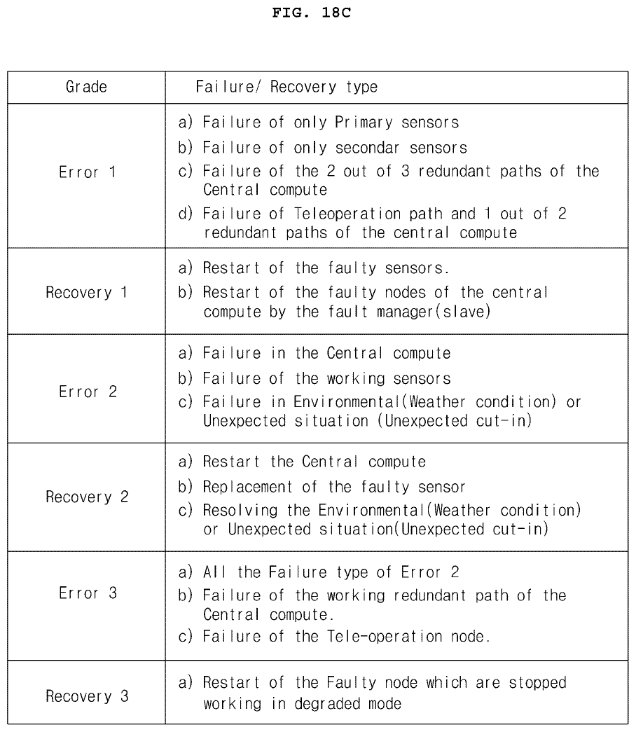

FIGS. 12A to 19C are diagrams referred to in the description of the operation of FIGS. 8 to 11.

FIG. 12A and FIG. 12B are diagrams exemplifying sensor data-based driving.

Referring to the drawings, a first service 2012 in the first zonal signal processing device 170z1 receives sensor data from a main sensor device SNa (S1210).

Next, the first service 2012 in the first zonal signal processing device 170z1 can analyze the received sensor data and transmit the sensor data to the central signal processing device 170 or the second zonal signal processing device 170z2 (S1215).

For example, services 2032 and 2034 in containers or redundant nodes 2036 and 2037, within the central signal processing device 170, can receive sensor data and make a perception and a driving determination (S1220).

Also, the voter 2025 in the central signal processing device 170 can be configured to generate a control message based on the sensor data (S1225).

For example, the voter 2025 in the central signal processing device 170 can be configured to generate a control message including an acceleration message, a deceleration message, or a steering angle message.

Also, the voter 2025 in the central signal processing device 170 can transmit the generated control message to the first zonal signal processing device 170z1.

Next, the actuator service 2011 in the first zonal signal processing device 170z1 can control the actuator SNc based on the control message.

For example, the actuator service 2011 in the first zonal signal processing device 170z1 can be configured to perform acceleration or deceleration or steering angle adjustment. Accordingly, safe driving can be made possible based on sensor data.

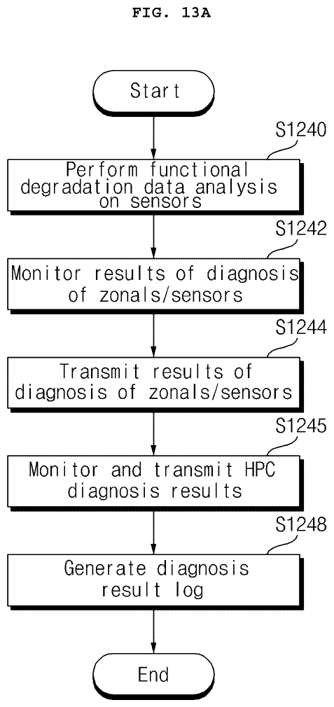

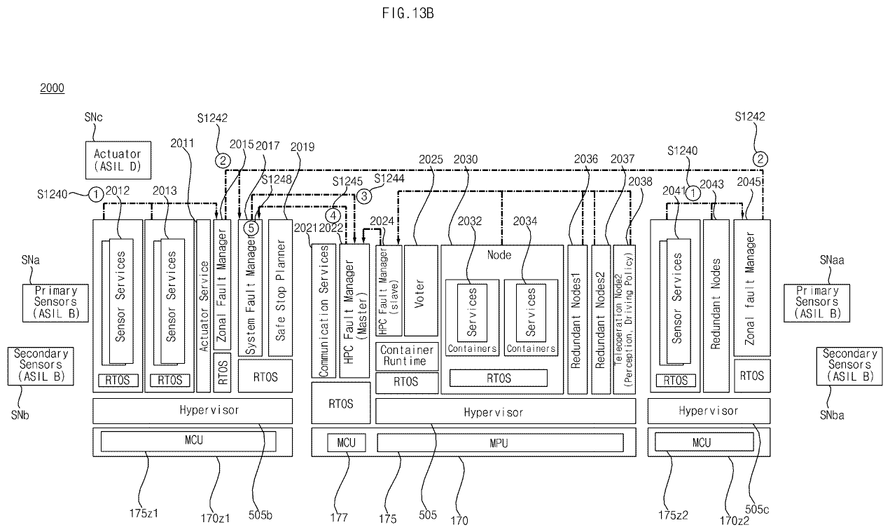

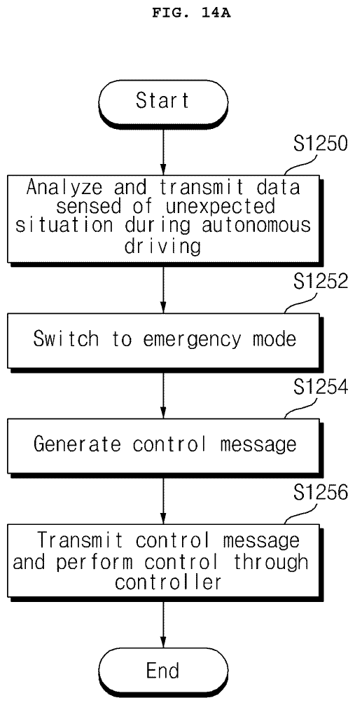

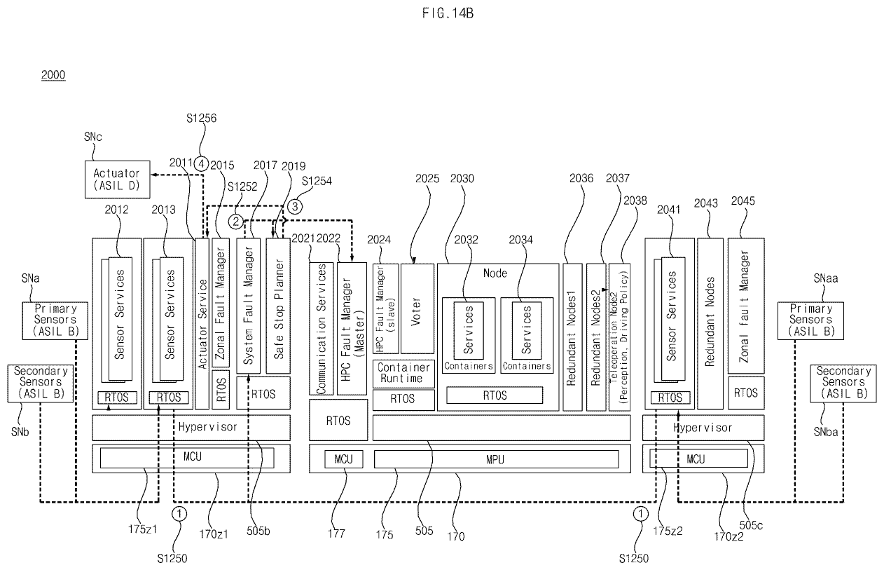

FIGS. 13A and 13B are diagrams exemplifying how a diagnosis result log is generated based on sensor data.

Referring to the drawings, the first service 2012 in the first zonal signal processing device 170z1 receives sensor data from a main sensor device SNa.

Next, during a normal mode, the first service 2012 in the first zonal signal processing device 170z1 performs functional degradation data analysis on the received sensor data (S1240).

For example in response to the amount of the sensor data or camera data being at or below a first reference value during the normal mode, the first service 2012 in the first zonal signal processing device 170z1 can be configured to determine that a functional degradation has occurred.

Next, sensor data or sensor data analyzed as a functional degradation is transmitted to a fault manager 2015 in the first zonal signal processing device 170z1.

The fault manager 2015 in the first zonal signal processing device 170z1 monitors diagnosis results based on the sensor data or the sensor data analyzed as a functional degradation (S1242).

Next, the fault manager 2015 in the first zonal signal processing device 170z1 can transmit diagnosis result data to the central signal processing device 170 (S1244).

For example, a fault manager 2022 in the central signal processing device 170 can receive diagnosis result data and perform diagnosis result monitoring based on the diagnosis result data (S1245).

Also, the fault manager 2022 in the central signal processing device 170 can transmit the diagnosis result data of the central signal processing device 170 to the first zonal signal processing device 170z1.

Next, a system fault manager 2017 in the first zonal signal processing device 170z1 can be configured to generate a diagnosis result log based on the diagnosis result data of the central signal processing device 170 (S1248). Accordingly, it is possible to perform monitoring based on a degradation of a function of a sensor device or the like and generate a diagnosis result log.

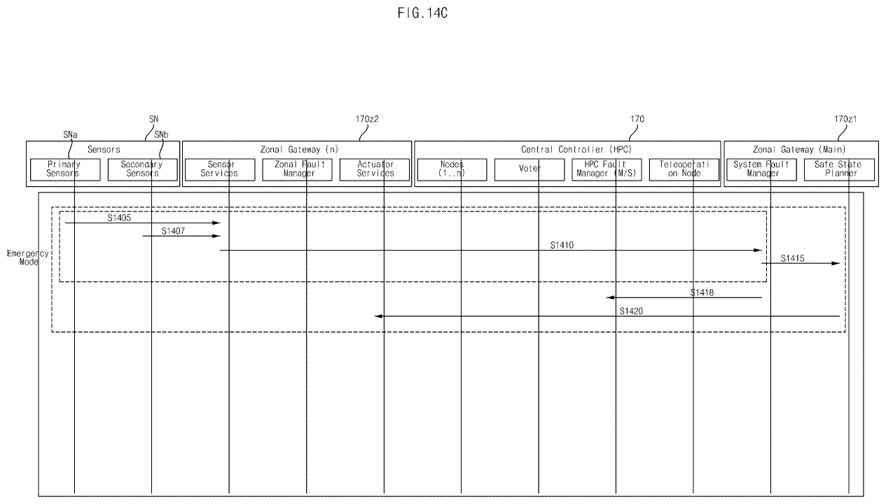

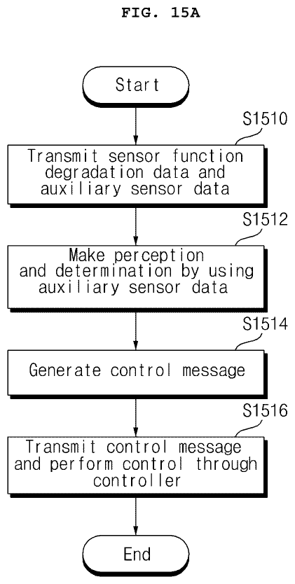

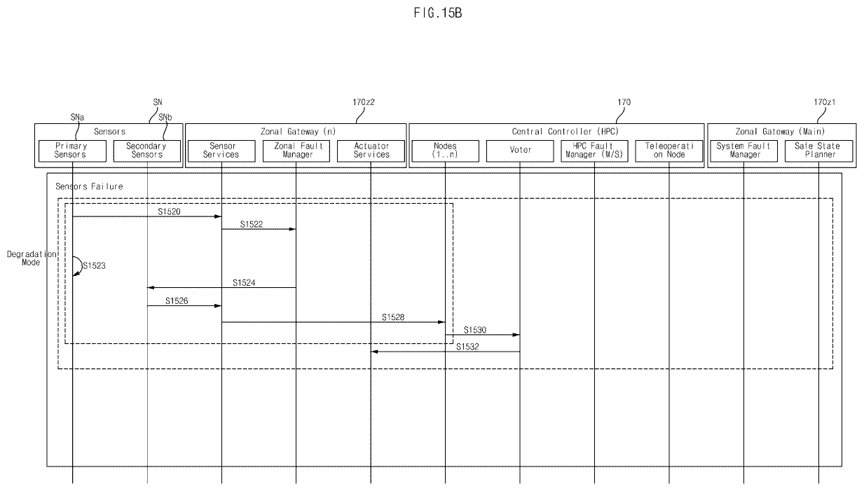

FIG. 14A and FIG. 14B are diagrams exemplifying how an unexpected situation is dealt with based on sensor data.

Referring to the drawings, the first service 2012 or second service 2013 in the first zonal signal processing device 170z1 receives sensor data from a main sensor device SNa or an auxiliary sensor device SNb.

Next, the first service 2012 or second service 2013 in the first zonal signal processing device 170z1 can analyze the received sensor data and transmit the analyzed sensor data or analyzed unexpected situation information to the system fault manager 2017 (S1250).

For example, the unexpected situation information can include information such as encountering a jaywalking child during vehicle driving or encountering a jaywalking pedestrian during nighttime driving or the position of an unexpected obstacle ahead.

The system fault manager 2017 in the first zonal signal processing device 170z1 can perform control so as to switch to an emergency mode based on the analyzed sensor data or the analyzed unexpected situation information (S1252).

Also, the system fault manager 2017 in the first zonal signal processing device 170z1 can transmit emergency mode information or emergency mode switching information to the safe stop planner 2019 or the central signal processing device 170.

Next, the safe stop planner 2019 in the first zonal signal processing device 170z1 can be configured to generate a control message based on the emergency mode information or the emergency mode switching information (S1254).

For example, the safe stop planner 2019 in the first zonal signal processing device 170z1 can be configured to generate a control message including an acceleration message, a deceleration message, or a steering angle message.

Also, the safe stop planner 2019 in the first zonal signal processing device 170z1 can transmit the generated control message to an actuator service 2011 in the first zonal signal processing device 170z1.

Next, the actuator service 2011 in the first zonal signal processing device 170z1 can control the actuator SNc based on the control message (S1256).

For example, the actuator service 2011 in the first zonal signal processing device 170z1 can be configured to perform acceleration or deceleration or steering angle adjustment. Accordingly, safe driving can be made possible in case of an unexpected situation.

FIG. 14C is a diagram referred to in the description of FIGS. 14A and 14B.

Referring to the drawing, the first service 2012 in the first zonal signal processing device 170z1 receives sensor data from a main sensor device SNa (S1405).

The second service 2013 in the first zonal signal processing device 170z1 receives sensor data from an auxiliary sensor device SNb or the main sensor device SNa (S1407).

Next, as in the step S1250, the first service 2012 or second service 2013 in the first zonal signal processing device 170z1 can analyze the received sensor data and transmit the analyzed sensor data or analyzed unexpected situation information to the system fault manager 2017 (S1410).

For example, the unexpected situation information can include information such as encountering a jaywalking child during vehicle driving or encountering a jaywalking pedestrian during nighttime driving or the position of an unexpected obstacle ahead.

Next, the system fault manager 2017 in the first zonal signal processing device 170z1 can perform control so as to switch to an emergency mode based on the analyzed sensor data or the analyzed unexpected situation information, and can transmit emergency mode information or emergency mode switching information to the safe stop planner 2019 or the central signal processing device 170 (S1415).

Next, the safe stop planner 2019 in the first zonal signal processing device 170z1 can be configured to generate a control message based on the emergency mode information or the emergency mode switching information.

Meanwhile, the safe stop planner 2019 in the first zonal signal processing device 170z1 can transmit the emergency mode information or the emergency mode switching information to the central signal processing device 170 (S1418).

Meanwhile, the safe stop planner 2019 in the first zonal signal processing device 170z1 can transmit the generated control message to an actuator service 2011 in the first zonal signal processing device 170z1 (S1420).

Next, the actuator service 2011 in the first zonal signal processing device 170z1 can control the actuator SNc based on the control message.

For example, the actuator service 2011 in the first zonal signal processing device 170z1 can perform control so as to bring the vehicle to an emergency stop by performing deceleration. Accordingly, safe driving can be made possible in case of an unexpected situation.

FIG. 15A is a diagram exemplifying a degradation mode related to a degradation of a sensor function.

Referring to the drawing, the first service 2012 in the first zonal signal processing device 170z1 receives sensor data from a main sensor device SNa and then activates an auxiliary sensor device SNb in case of degradation of a sensor function.

Next, the second service 2013 in the first zonal signal processing device 170z1 receives sensor data from the auxiliary sensor device SNb (S1510).

Next, the second service 2013 in the first zonal signal processing device 170z1 transmits the sensor data from the auxiliary sensor device SNb to the central signal processing device 170.

Meanwhile, the voter the central signal processing device 170 can make a perception or determination based on the sensor data (S1512) and generate a control message based on the perception or determination (S1514).

Also, the voter 2025 in the central signal processing device 170 can transmit the generated control message to the first zonal signal processing device 170z1.

Next, the actuator service 2011 in the first zonal signal processing device 170z1 can control the actuator SNc based on the control message (S1516).

Accordingly, safe driving can be made possible by using the t auxiliary sensor device SNb, in case of a degradation of a function of the main sensor device SNa.

FIG. 15B is a diagram referred to in the description of FIG. 15A.

Referring to the drawing, in the normal mode, the main sensor device SNa transmits sensor data to the first service 2012 in the first zonal signal processing device 170z1 (S1520).

In response to this, the first service 2012 in the first zonal signal processing device 170z1 can receive the sensor data from the main sensor device SNa, analyze the sensor data, and transmit analysis result data or the sensor data to the fault manager 2015 (S1522).

During the normal mode, in response to the amount of the sensor data or camera data received being at or below a first reference value, the fault manager 2015 can be configured to determine that a function of the sensor has degraded and transmit an activation message to the auxiliary sensor device SNb (S1524).

In relation to this, the main sensor device SNa can enter into a degradation mode (S1523).

Meanwhile, the auxiliary sensor device SNb can be activated, thereby transmitting the sensor data to the second service 2013 in the first zonal signal processing device 170z1 (S1526).

In response to this, the second service 2013 in the first zonal signal processing device 170z1 can receive the sensor data from the auxiliary sensor device SNb and transmit the sensor data to a node in the central signal processing device 170 (S1528).

Next, the voter 2025 in the central signal processing device 170 can receive the sensor data (S1530), make a perception or determination based on the sensor data, generate a control message based on the perception or determination, and transmit the generated control message to the first zonal signal processing device 170z1 (S1532).

Next, the actuator service 2011 in the first zonal signal processing device 170z1 can control the actuator SNc based on the control message.

Accordingly, safe driving can be made possible by using the auxiliary sensor device SNb, in case of a degradation of a function of the main sensor device SNa.

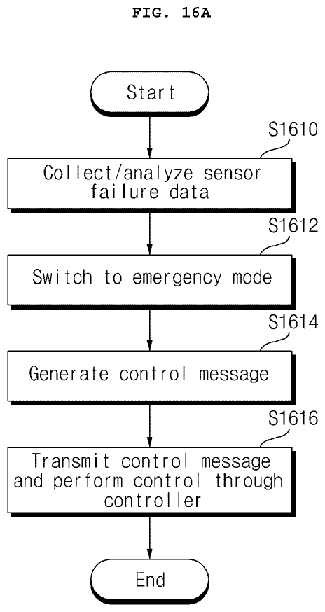

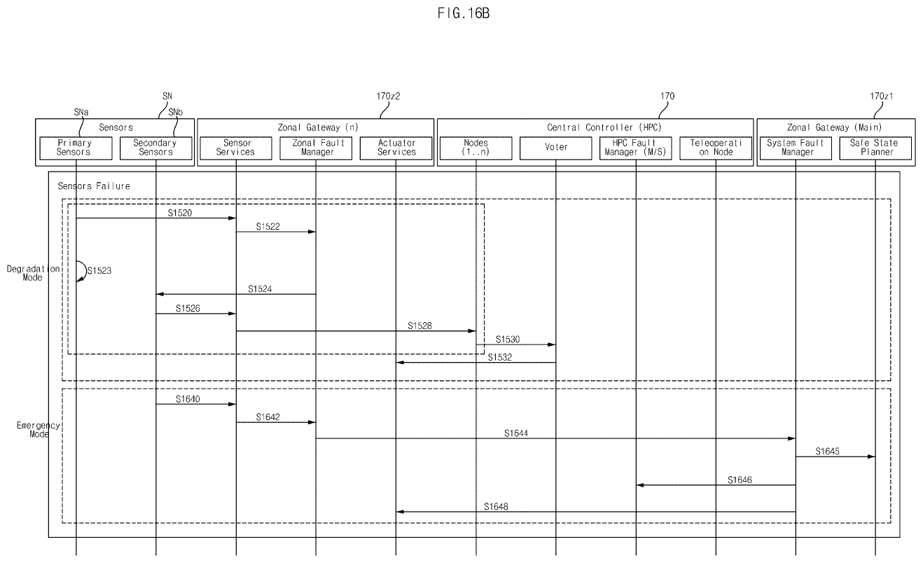

FIG. 16A is a diagram exemplifying how an emergency mode is triggered by a sensor device failure.

Referring to the drawing, the first zonal signal processing device 170z1 receives sensor data from a sensor device SN and then collects or analyzes relevant data in response of a failure of the sensor device SN (S1610).

Next, the first zonal signal processing device 170z1 switches to the emergency mode (S1612).

For example, in response to the amount of the sensor data or camera data received being at or below a second reference value which is lower than the first reference value, the first zonal signal processing device 170z1 can be configured to determine that the sensor device SN or the camera 195 has a failure and perform the emergency mode.

Meanwhile, in the emergency mode, the first zonal signal processing device 170z1 can be configured to transmit failure information or emergency mode initiation information to the central signal processing device 170.

Next, the processor 175z in the first zonal signal processing device 170z1 can be configured to generate an emergency control message based on the emergency mode (S1615) and emergently control the actuator SNc based on the emergency control message (S1616).

For example, the processor 175z in the first zonal signal processing device 170z1 can emergently control the actuator SNc so as to bring the vehicle to an emergency stop.

Accordingly, the vehicle can be brought to an emergency stop in case of a sensor device failure.

FIG. 16B is a diagram referred to in the description of FIG. 16A.

Referring to the drawing, the steps S1520 to S1532 correspond to the degradation mode of FIG. 15B.

During the degradation mode, the auxiliary sensor device SNb can transmit sensor data to the second service 2013 in the first zonal signal processing device 170z1 (S1640).

In response to this, the second service 2013 in the first zonal signal processing device 170z1 can receive the sensor data from the auxiliary sensor device SNb, analyze the sensor data, and transmit analysis result data or the sensor data to the fault manager 2015 (S1642).

Next, in response to determining that a sensor device failure has occurred, the fault manager 2015 in the first zonal signal processing device 170z1 can transmit sensor device failure information to the system fault manager 2017 in the first zonal signal processing device 170z1 (S1644).

Meanwhile, the system fault manager 2017 in the first zonal signal processing device 170z1 can perform control so as to switch to the emergency mode based on the sensor device failure information.

Next, the system fault manager 2017 in the first zonal signal processing device 170z1 can transmit emergency mode information or emergency mode switching information to the safe stop planner 2019 (S1645).

Next, the safe stop planner 2019 in the first zonal signal processing device 170z1 can transmit the emergency mode information or the emergency mode switching information to the central signal processing device (S1646).

Meanwhile, the safe stop planner 2019 in the first zonal signal processing device 170z1 can be configured to generate a control message based on the emergency mode information or the emergency mode switching information and transmit the control message to the actuator service 2011 in the first zonal signal processing device 170z1 (S1648).

Next, the actuator service 2011 in the first zonal signal processing device 170z1 can control the actuator SNc based on the control message.

For example, the actuator SNc can bring the vehicle to an emergency stop. Accordingly, the vehicle can be brought to an emergency stop in case of a sensor device failure.

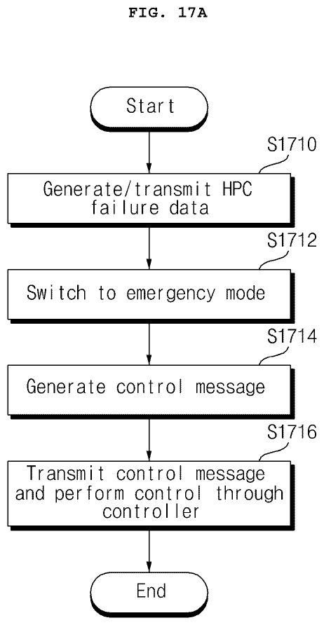

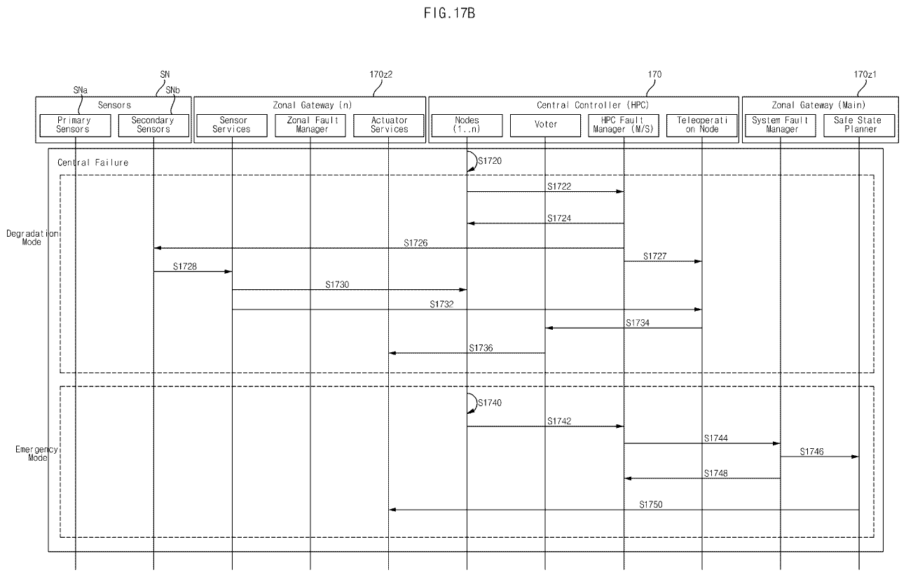

FIG. 17A is a diagram exemplifying how an emergency mode is triggered by a central signal processing device failure.

Referring to the drawing, in response of a failure of the central signal processing device 170, failure data can be generated and transmitted to the first zonal signal processing device 170z1 (S1710).

The first zonal signal processing device 170z1 switches to the emergency mode in response to receiving the failure data from the central signal processing device 170 (S1712).

Also, the first zonal signal processing device 170z1 can be configured to generate a control message based on sensor data received from a sensor device SN (S1714) and control the actuator SNc based on the generated control message (S1716).

For example, in response to determining that the central signal processing device 170 has a failure, the processor 175z in the first zonal signal processing device 170z1 can be configured to switch to the emergency mode, generate a control message for replacing the central signal processing device 170, and operate the sensor device SN or the camera 195 or the actuator SNc, based on the control message.

Accordingly, in response of a failure of the central signal processing device 170, the first zonal signal processing device 170z1 can be used instead, thereby allowing for safe driving of the vehicle.

FIG. 17B is a diagram referred to in the description of FIG. 17A.

Referring to the drawing, the steps S1720 to S1736 exemplify the degradation mode, and the steps S1740 to S1750 illustrate the emergency mode.

Meanwhile, in case of a functional degradation of the central signal processing device 170, a node in the central signal processing device 170 generates functional degradation data (S1720) and transmits the functional degradation data to the fault manager 2022 (S1722).

Next, the fault manager 2022 in the central signal processing device 170 transmits deactivation information to the node in the central signal processing device 170 (S1724).

Next, the fault manager 2022 in the central signal processing device 170 transmits auxiliary sensor device activation information to the first zonal signal processing device 170z1 (S1725).

Meanwhile, the fault manager 2022 in the central signal processing device 170 can transmit the activation information to a teleoperation node (S1727).

Meanwhile, the auxiliary sensor device SNb is activated, and the auxiliary sensor device SNb transmits sensor data (S1728).

Next, the second service 2013 in the first zonal signal processing device 170z1 receives the sensor data from the auxiliary sensor device SNb and transmits the sensor data to the central signal processing device 170.

At this point, the sensor data from the auxiliary sensor device SNb can be transmitted to the node in the central signal processing device 170 (S1730), and also can be transmitted to the activated teleoperation node in the central signal processing device 170 (S1732).

Next, the node or teleoperation node can make a perception or driving determination based on the received sensor data.

Also, the voter 2025 in the central signal processing device 170 can be configured to generate a control message based on the sensor data.

For example, the voter 2025 in the central signal processing device 170 can be configured to generate a control message including an acceleration message, a deceleration message, or a steering angle message.

Also, the voter 2025 in the central signal processing device 170 can transmit the generated control message to the first zonal signal processing device 170z1 (S1736).

Next, the actuator service 2011 in the first zonal signal processing device 170z1 can control the actuator SNc based on the control message.

Accordingly, safe driving can be made possible based on the sensor data from the auxiliary sensor device.

Meanwhile, in response of a failure of the central signal processing device 170, the node in the central signal processing device 170 generates failure data (S1740) and transmits the failure data to the fault manager 2022 (S1742).

Next, the fault manager 2022 in the central signal processing device 170 transmits deactivation information to the node in the central signal processing device (S1724).

Next, the fault manager 2022 in the central signal processing device 170 transmits the failure data of the central signal processing device 170 (S1744).

Next, the system fault manager 2017 in the first zonal signal processing device 170z1 receives the failure data of the central signal processing device 170 and activates the emergency mode.

Also, the system fault manager 2017 in the first zonal signal processing device 170z1 can transmit emergency mode information to the safe stop planner 2019 (S1746).

Next, the system fault manager 2017 in the first zonal signal processing device 170z1 can transmit the emergency mode information to the central signal processing device 170 (S1748).

Next, the safe stop planner 2019 in the first zonal signal processing device 170z1 can transmit a generated control message to the actuator service 2011 in the first zonal signal processing device 170z1, based on the emergency mode information (S1750).

Next, the actuator service 2011 in the first zonal signal processing device 170z1 can control the actuator SNc based on the control message.

For example, the actuator service 2011 in the first zonal signal processing device 170z1 can perform control so as to bring the vehicle to an emergency stop by performing deceleration. Accordingly, the vehicle can be brought to an emergency stop in response of a failure of the central signal processing device 170.

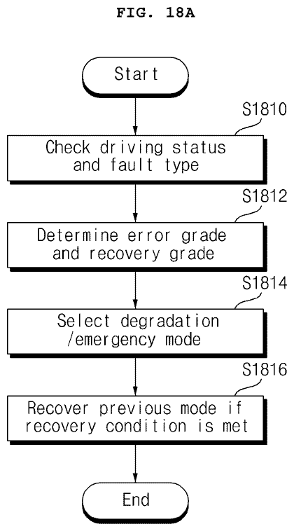

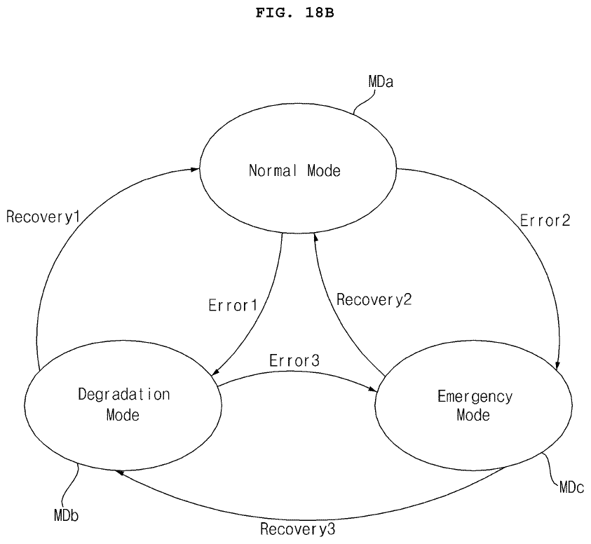

FIGS. 18A to 18C are diagrams illustrating an operation based on vehicle driving status and fault type information.

FIG. 18A illustrates a flowchart of an operation based on vehicle driving status and fault type information.

Referring to the drawing, the processor 175z in the first zonal signal processing device 170z1 checks driving status information and fault type information (S1810).

Next, the processor 175z can be configured to determine an error grade or a recovery grade based on the driving status information and the fault type information (S1812).

Next, the processor 175z can perform the emergency mode or the degradation mode, based on the error grade or the recovery grade (S1814). Accordingly, it is possible to stably perform vehicle driving in the emergency mode or the degradation mode.

Next, during the emergency mode or the degradation mode, the processor 175z can be configured to recover the previous mode in response to satisfaction of a recovery condition (S1816). Accordingly, it is possible to stably perform vehicle driving.

Meanwhile, the steps S1810 to S1816 are applicable to the operation of the processor 175 in the central signal processing device 170, as well as the operation of the processor 175z in the first zonal signal processing device 170z1.

FIG. 18B is a diagram illustrating errors and recovery among the normal mode, the degradation mode, and the emergency mode. FIG. 18C is a diagram illustrating various error types and recovery, among the normal mode, the degradation mode, and the emergency mode.

Referring to the drawing, when Error 1 occurs, the degradation mode MDb can be initiated from the normal mode MDa, when Error 2 occurs, the emergency mode MDc can be initiated from the normal mode MDa, and when Error 3 occurs, the emergency mode MDc can be initiated from the degradation mode MDb.

Meanwhile, a transition from the degradation mode MDb to the normal mode MDa can be made according to Recovery 1, a transition from the emergency mode MDc to the normal mode MDa can be made according to Recovery 2, and a transition from the emergency mode MDc to the degradation mode MDb can be made.

Meanwhile, Error 1 can be a failure of the main sensor device SNa or a failure of the auxiliary sensor device SNb or the like.

Error 2 can be a failure of the central signal processing device or the like.

Error 3 can include the failure type of Error 2, or can be a failure of the redundant path.

It will be apparent that, although the preferred embodiments have been shown and described above, the present disclosure is not limited to the above-described specific embodiments, and various modifications and variations can be made by those skilled in the art without departing from the gist of the appended claims. Thus, it is intended that the modifications and variations should not be understood independently of the technical spirit or prospect of the present disclosure.

1. A signal processing device configured to exchange data with a central signal processing device, the signal processing device comprising a processor configured to, in a normal mode, transmit sensor data received from a sensor device or camera data received from a camera to the central signal processing device,
wherein the processor is configured to perform an emergency mode in response of a failure of the central signal processing device or the sensor device or the camera.

2. The signal processing device of claim 1, wherein, in the normal mode, the processor is configured to control the sensor device or the camera or an actuator to operate, based on a control signal received based on transmission of the sensor data or the camera data.

3. The signal processing device of claim 1, wherein in response to the amount of the sensor data or camera data being at or below a first reference value during the normal mode, the processor is configured to determine that the performance of the sensor device or the camera is degraded and transmit performance degradation information or degradation mode initiation information to the central signal processing device.

4. The signal processing device of claim 3, wherein, in response to the amount of the sensor data or camera data received being at or below a second reference value which is lower than the first reference value, the processor is configured to determine that the sensor device or the camera has a failure and perform the emergency mode.

5. The signal processing device of claim 1, wherein, in the emergency mode, the processor is configured to transmit failure information or emergency mode initiation information to the central signal processing device.

6. The signal processing device of claim 1, wherein in response to the amount of the sensor data or camera data received being at or below the first reference value during the normal mode, the processor is configured to transmit second sensor data or second camera data received from another sensor device or camera different from the sensor device or camera to the central signal processing device.

7. The signal processing device of claim 1, wherein the processor is configured to execute a hypervisor and execute a zonal fault manager on the hypervisor.

8. The signal processing device of claim 7, wherein the processor is further configured to execute a sensor service on the hypervisor for transmitting the sensor data or the camera data,
wherein the safety level of the zonal fault manager is higher than the safety level of the sensor service.

9. The signal processing device of claim 7, wherein the processor is further configured to execute a system fault manager on the hypervisor,
wherein the safety level of the zonal fault manager and the safety level of the system fault manager are the same.

10. The signal processing device of claim 1, wherein the processor is configured to execute a system fault manager,
wherein the system fault manager is configured to generate a diagnosis result log based on diagnosis result data received from the central signal processing device.

11. The signal processing device of claim 1, wherein the processor is configured to control the sensor device or the camera or an actuator to operate, based on a control signal received based on transmission of the sensor data or the camera data,
wherein the safety level of the actuator is higher than the safety level of the sensor device or the camera.

12. The signal processing device of claim 2, wherein the processor is configured to generate an emergency control message based on the emergency mode and emergently control the actuator based on the emergency control message.

13. The signal processing device of claim 1, wherein, in response to determining that the central signal processing device has a failure, the processor is configured to switch to the emergency mode, generate a control message for replacing the central signal processing device, and operate the sensor device or the camera or the actuator based on the control message.

14. The signal processing device of claim 1, wherein the processor is configured to determine an error grade or a recovery grade based on driving status information and fault type information, and perform the emergency mode or the degradation mode, based on the error grade or the recovery grade.

15. The signal processing device of claim 14, wherein, during the emergency mode or the degradation mode, the processor is configured to recover the previous mode in response to satisfaction of a recovery condition.

16. A signal processing device configured to exchange data with a zonal signal processing device, the signal processing device comprising a processor configured to execute an application for driving the vehicle, based on sensor data or camera data received from the zonal signal processing device,
wherein, in response to receiving performance degradation information or degradation mode initiation information from the zonal signal processing device, the processor is configured to perform the degradation mode.

17. The signal processing device of claim 16, wherein the processor is configured to transmit diagnosis result data of the sensor data or camera data to the zonal signal processing device, based on sensor data or camera data received from the zonal signal processing device.

18. The signal processing device of claim 16, wherein the processor is configured to execute the hypervisor and execute a plurality of virtual machines on the hypervisor,
wherein one of the plurality of virtual machines is configured to execute a fault manager.

19. The signal processing device of claim 18, wherein the processor is configured to execute a second fault manager,
wherein the safety level of the second fault manager is higher than the safety level of the fault manager executed on the hypervisor.

20. A vehicle display apparatus comprising:
at least one display;
a zonal signal processing device configured to receive sensor data or camera data from a sensor device or a camera; and
a central signal processing device configured to output an image signal to the display, based on the sensor data or the camera data,
wherein the zonal signal processing device comprises a processor configured to, in a normal mode, transmit sensor data received from a sensor device or camera data received from a camera to the central signal processing device,
wherein the processor is configured to perform an emergency mode in response of a failure of the central signal processing device or the sensor device or the camera.
